(19) United States
(12) Patent Application Publication
(10) Pub. No.: US 2023/0335005 A1
(43) Pub. Date: Oct. 19, 2023

(54) SYSTEM AND METHOD FOR AUTOMATED CURRICULUM AND TEACHER TRAINING MATERIALS DEVELOPMENT

(71) Applicant: Meyrav MOR, Kathmandu (NP)

(72) Inventor: Meyrav MOR, Kathmandu (NP)

(21) Appl. No.: 18/298,700

(22) Filed: Apr. 11, 2023

Related U.S. Application Data
(60) Provisional application No. 63/362,964, filed on Apr. 14, 2022.

(51) Int. Cl. G09B 19/00

(52) U.S. Cl. CPC G09B 19/00

(57) ABSTRACT

The system and method of the present teachings form a spiritually, developmentally, pedagogically, and culturally transformative experiential education that includes curriculum (kindergarten-class 12) and a teacher training program that can be adapted to a target community, for children aged three to fourteen. The system and method of the present teachings rely on establishing a foundation for the curriculum of understanding human development and the nature of the human being from the specific human subset.

### CROSS REFERENCE TO RELATED APPLICATIONS

This application claims the benefit of U.S. Provisional Application No. 63/362,964 filed on Apr. 14, 2022, which is hereby incorporated by reference in its entirety.

### BACKGROUND

The present teachings relate generally to education systems including student education and teacher training.

The framework that an education system can be built upon can include a spiritual philosophy and a pedagogical philosophy. Ontology, a branch of philosophy, includes questions of how entities are grouped into basic categories and which of these entities exist on the most fundamental level. Epistemology includes the investigation of what distinguishes justified belief from opinion. Education aims to develop the inner being towards liberation as defined in the epistemology of an ontological group. An education system developed for a particular group, for example, a cultural group, an age group, an ethnic group, or a combination can provide benefits for the students and teachers. The educational system for a particular group is reflective of, for example, spiritual beliefs and rituals, transformative religious/spiritual experience and knowing, philosophy, ethnography, traditional cultural knowledge, social norms and practices, local environment, wilderness, farming, and sustainable development.

A spiritual philosophy such as Buddhism can be used to complement a pedagogical philosophy such as the Waldorf/Steiner education approach, and can be enhanced with progressive education, experiential learning, and integrated learning to create a transformative or contemplative learning methodology. The learning methodology accompanied by a system to train teachers imparts information in the context of the learning methodology. The training system addresses, among other things, a teacher's inner development, child development and human development, the learning methodology, curriculum content and application, and the wellbeing of the child and school.

What is needed is a system to merge cultural features of a target population with spiritual and pedagogical philosophies. Such a system can implement an educational philosophy and complementary education training philosophy that integrates cultural features of a target population with desired spiritual and pedagogical frameworks.

### SUMMARY

The system and method of the present teachings form a spiritually, developmentally, pedagogically, and culturally transformative experiential education that includes curriculum (kindergarten-class 12) and a teacher training program (divided into 3 different specializations: kindergarten, primary and secondary teacher training courses) that can be adapted to a target community, be it a Buddhist or a non-Buddhist community, for children aged three to fourteen. In an aspect, the epistemology (the worldview relating to the relationship between the knower and the known) employed in this system is Buddhist. In an aspect, the worldview or lens of the system and method relies on establishing the foundation for the curriculum to rest on the ontology and epistemology of Buddhism, and through that lens, engages with the specific culture/group/nation/religion/spiritual path, the philosophical and spiritual belief system of the specific set of people. The epistemology or relationship between the knower and the known is connected with the Buddhist view of fake relative reality (linked with unhealthy sense of self) and true relative reality (linked with healthy sense of self). The system and method of the present teachings rely on establishing a foundation for the curriculum of understanding human development and the nature of the human being from the specific human subset. For example, Buddhist worldview also includes Buddhist psychology in Abhidharma, suttas, sutras and many commentaries, as well as Kalachakra and other such tantra, Vajrayana texts, and more. What is a self and how a self develops are studied and linked with developmental science (that is, developmental psychology, neuroscience, sociology, anthropology, child development, pediatric medicine, biology), Steinerian psychology, and holistic medicine, such as, anthroposophical medicine and Tibetan medicine).

The education methodology of the present teachings is the integration and merging of three main views of learning theories and methodologies, starting with (1) the Buddha's three-fold qualities of wisdom, compassion and enlightened action and head, heart and doing, (2) the methodology of Buddhist view, meditation and application, and (3) the three wisdoms or prajnas of hearing, contemplating and meditating. Taken together, they form a way for deepening a person's experience and making it more direct. Within this is woven Steiner's transformational learning, and other contemporary learning theories, such as John Dewey, the progressive education which encompasses experiential, integrated and cooperative learning, recognizing the multidimensional ways in which people learn and make sense of the world and inner life.

The system and method of the present teachings translate and interpret the Buddhist learning methodology and pedagogy into children's pedagogy through using the Steiner/Waldorf transformative education approach and aspects of progressive education. The transformative experiential Buddhist learning style can be described as a nested system that includes skills, contemplation, inquiry and reflection, creativity, and self-transformation. The system and method are centered on self-transformation with a focus on enabling a paradigm shift in how children and teachers learn, teach, perceive and experience the world. The integrated children's transformative experiential Buddhist methodology of the present teachings gives weight to the knowing/intellectual (head) affective/feelings (heart), and will/doing/action/conduct/habits (hand) domains. The learning methodology and Buddhist worldview (that resemble universal values and ethics) of the present teachings is integrated into the educational subjects. Ethics and values are at the heart of the learning. The learning methodology of the present teachings can be applied to other traditions.

A description of a practical application of the system and method of the present teachings, including automatic formulation of teacher training courses and kindergarten to class 8 curriculum content, is provided herein. The practical application is part of a larger context that is described as follows. The context includes the elements of being, knowing, learning, and doing. In this example, being is informed by experiential Buddhist Foundation studies, and the teacher's inner development, view, meditation, and application/conduct. Knowing is informed by human development from the Buddhist, Steiner, developmental science, developmental psychology and developmental neuroscience perspectives, and learning theories and approaches from Buddhist, Steinerian and other contemporary theories. Learning is informed by the curriculum formed from the method of the present teachings for kindergarten and primary education (classes 1-8). Living together with others is informed by artistic disciplines, and professional, organizational and social aspects of teaching according to the curriculum formed by the method of the present teachings. Doing is informed by bringing together handwork, craft, woodwork, metal work, stone carving, pottery, bushcraft, nature-based learning with awareness meditation. Also, practical competencies, such as teaching practice and practicum.

Establishing a foundation for the curriculum involves researching and studying ethnography and the specific religion and or spiritual beliefs study of the specific culture/group/nation/religion. In creating a template for a curriculum and a teacher training course, values are consciously cultivated that are embedded in their own spirituality and religious values as well as cultural heritage. As an example, Waldorf education methodology employs a transformative experiential, integrated holistic approach to education that can be used as a base for the modality and template to create a transformative experiential curriculum and teacher training that can process content of different spiritual and cultural heritages to create a custom-made localized education program including various traditions. Extensive research and understanding of the group's spirituality/religion/philosophical worldview, cultural heritage, social norms and practices, language, farming, geographical location, wilderness, farming, spiritual practices, medicinal practices, belief system, relationship to nature, and understanding the group's present reality form the raw material or content feed into the system of the present teachings. The content that is processed through an educational methodology (such as the Waldorf methodology) and pedagogy together with Buddhist, contemplative practices that are at the same time universal ethics, such as, mindfulness and awareness, non-violence, joy, love, kindness, compassion, equanimity, interconnection and interdependence, can be used to create a transformative experiential curriculum that is specific to the group in mind.

The curriculum template of the present teachings supports inner development, transformative experiential learning, contemplation, and preservation of heritage by way of incorporating traditional arts, songs, music, spiritual heritage, myths and stories that can secure the specific culture for future generations. Such a curriculum brings a sense of connection and mutual understanding as the children learn about their roots and those of other groups within the countries where they reside. Furthermore, the curriculum template formed by the method of the present teachings addresses issues such as social integration, inclusion, community-based schooling, children at risk, and other culturally relevant factors that influence a child's development. The template can, for example, encourage the use of traditional local materials and craftsmanship in creating the classroom educational equipment.

The curriculum template captures a specific group's understanding of educating the human being in relation to its spirituality, sustainable development, their local environment heritage, local tradition, festivals, seasons, and environs. The guiding compass to include appropriate knowledge from the specific group is to weave it through contemplative science, ancient Buddhist wisdom, and universal ethics. Based on this common ground, positive self-esteem and self-identity can be encouraged, keeping the children connected to their communities, their environment, and their traditions, and at the same time help them progress on the path of inner development to grow up healthy in body and mind and have the tools to meet the challenges of our times. The stages for developing and implementing the bespoke system of the present teachings includes curriculum research and creation, compiling, publishing, and translating curriculum resources for teachers and children, and teacher training. Curriculum research includes adapting a curriculum template for kindergarten and primary classes 1-8 to develop an education program for a specific culture/group/religion/ethnic group/tradition. Compiling, publishing, and translating resources includes compiling curriculum guidebooks for teachers, lesson books for teachers, resource books for teachers, and children's books based on the adapted curriculum template. The resources are translated to the specific language of the target group. Teacher training includes adapting a teacher training template to include the specific knowledge of the group the curriculum has been developed for. Teachers can be trained, either in person or remotely, using the resources and curriculum. Mentoring and assessment programs are developed based on the adapted curriculum template to monitor the progress of the teachers and students under the developed curriculum.

In some configurations, the system of the present teachings includes, but is not limited to including, a processor executing instructions to sort data from a target population into a first set of categories including, but not limited to including, ethnographic, spiritual, and historical data. Sorting can be done using a tag method in which words are given tags, and tags are used for sorting. Tags correspond to a pre-selected set of features. Assigning tags to target data words can be performed using a natural language similarity process, or even a manual process. Further tagging can occur with a second set of categories, a third, etc. depending upon the design of the system. In some configurations, the tagged data from the first set of categories are sorted according to a second, third, and fourth set of categories. The result is used to generate curricula, lesson handbooks, and teacher training slides, which are used to generate resource lists.

In some configurations, the system of the present teachings includes, but is not limited to including, a processor executing instructions to sort data from a target population into a first set of categories including, but not limited to including, ethnographic, spiritual, and historical data. Sorting can be done using a bag-of-words representation in which words and/or n-grams of words from each category can be used as features, and the quanta of target data can be represented as a vector in metric space. Vector space models represent text as a vector of identifiers, and can determine whether various texts are similar in meaning even if they don't share the same words. Different designs can be used to represent text as vectors, for example, word-by-word, or word-by-doc. In a word-by-word method, the number of times a word occurs within a certain distance is tabulated. In a word-by-doc method, the number of times words from a selected list0 appear in collections that belong to pre-selected categories is tabulated, and thus the relationships between types of collections can be determined. Algebraic and trigonometric relationships are employed to quantify the similarity between texts. See Mikolov et al, 2013, Distributed Representations of Words and Phrases and their Compositionality, https://arxiv.org/abs/1310.4546, incorporated by reference herein in its entirety. Although similarity can be determined by the word-by-word and word-by-doc methods, semantic meaning requires more sophisticated technology such as, for example, the word2vec, doc2vec and transformer-based language model methods. These methods represent words as feature vectors, or encode a word's position in the text as well as the word itself, thus determining semantic textual similarity, and a contextual representation of language. In transformer-based language model methods, both target group information and categories are vectorized. Further, non-textual target group data can be encoded as vectors and thus become useful data for the system of the present teachings. By methods such as the exemplary methods described herein and other such methods, the target data are organized into categories.

Target data and data collection for an exemplary configuration are described herein. The system of the present teachings contemplates target data having virtually any characteristics. The target data set out herein is exemplary only. In the exemplary configuration, information is collected about Buddhist culture, local culture, sustainable development, and local government. With respect to Buddhist culture, literature research and content from Buddhist scholars and teachers about Buddhist philosophy, psychology, ethics, rituals, ceremonies, prayers, customs, practices, shamata (calm abiding) and vipassana (insight) meditations, and deities practices are collected. With respect to local culture, religious, ethnographic, and learning methodology information are collected. With respect to the local religious culture, philosophy, ethics, values, ceremonies, rituals, and understanding of human development and nature of reality information are collected and categorized according to their relationship to contemplative science and Buddhist universal values. With respect to local ethnography, rituals, ceremonies, traditional cultural knowledge, and family values information are collected and categorized according to their relationship with contemplative science and contemplative traditions rooted in Buddhist wisdom. Information is collected about local traditional learning methodology for children and adults.

After collecting the information as above, the data are either tagged or processed by a natural language analysis method as described herein, or a combination, or other ways of processing natural language. A first set of features that are used to sort the data can include, but is not limited to including, nature, the economy, social values, religious/spiritual beliefs, and cultural heritage. As described herein, the data and the features can be analyzed by a transformed-based method that can be used to sort the data into the feature categories.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for training teachers to provide a bespoke curriculum for a group. The method also includes creating a curriculum; adapting the curriculum to the group, compiling resources for the teachers and students of the teachers based on the adapted curriculum, adapting a teacher training template to the group. The method also includes conducting a teacher training course based on the adapted template, the adapted curriculum, and the resources. Other embodiments of this aspect include corresponding computer systems, apparatus, and computer programs recorded on one or more computer storage devices, each configured to perform the actions of the methods.

Implementations may include one or more of the following features. The method as where creating the curriculum may include: accessing a first content from Buddhist philosophy, Buddhist view, meditation and application, Buddhist ethics, rituals, ceremonies, prayers, customs, practices, shamata and vipassana meditation, deities practices, a transformational education approach, and a progressive education approach; accessing a second content from a philosophy, ethics, values, experiential, meditation, conduct, ceremonies, and rituals of the group; accessing a third content from rituals, ceremonies, and cultural knowledge of individuals in the group; accessing a fourth content from teaching methodologies of the group; accessing a fifth content from teaching methodologies of sustainable practices of the group; forming an ordered list by merging the first content with the second content, the third content, the fourth content, and the fifth content; and modifying the ordered list according to laws of the group to form the curriculum. Adapting the curriculum may include: studying the group; creating lessons appropriate to an age of the students, the lessons integrating ontology, epistemology, and a spiritual tradition of the group; and creating explanations of the lessons for the teachers. The method as may include: translating the resources to a language of the group. The group may include: a culture, religious, or ethnic group. Implementations of the described techniques may include hardware, a method or process, or computer software on a computer-accessible medium.

One general aspect includes a system for developing curricula for a group and training teachers a processor executing instructions including: collecting and tagging target data, the tagging being based upon an association between the target data and one or more members of a pre-selected list of categories; receiving and tagging feature data, the tagging being based upon an association between the feature data and one or more members of the pre-selected list of categories; associating lesson materials with one or more members of the pre-selected list of categories; automatically populating elements of the curricula with the target data, the feature data, and the lesson materials by associating each element of the curricula with one or more members of a pre-selected list of categories; locating resources based at least upon the populated elements of the curricula; and creating teacher training curricula and teacher training materials based at least upon the curricula and the resources. Other embodiments of this aspect include corresponding computer systems, apparatus, and computer programs recorded on one or more computer storage devices, each configured to perform the actions of the methods.

Implementations may include one or more of the following features. The system as where the pre-selected list of categories may include: Buddhist culture, local culture, sustainable development, local government, economy, social construct, values/relations, nature, spirituality/religion, levels of knowing, whole system, community of subjects, ecological world view, and Buddhist perspectives and ethics. The system as may include: automatically deriving or supplying missing of the target data. The target data may include: data about culture of the group; and data about agriculture, rituals, and spirituality in a region occupied by the group. The data about the culture of the group may include: religious information, ethnographic information, and learning methodology information about the group. The data about the religious information of the group may include: philosophy, ethics, values, ceremonies, rituals, and understanding of human development and nature of reality information categorized according to their relationship to contemplative science and Buddhist universal values. The data about the ethnographic information of the group may include: rituals, ceremonies, traditional cultural knowledge, and family values information categorized according to their relationship with contemplative science. Implementations of the described techniques may include hardware, a method or process, or computer software on a computer-accessible medium.

One general aspect includes a method for developing a bespoke transformative experiential education. The method also includes identifying a group to receive the education; determining a worldview and ontology of the group, determining an aim of education of the group. The method also includes accessing information associated with the group; determining methodology and philosophy of education of the group; creating a teacher training dataset by processing the worldview, the ontology, the aim of education, the information, and the methodology and philosophy of education according to a Buddhist learning methodology, a transformational education approach, and a progressive education approach; and creating a student curriculum and a teacher training based at least upon the teacher training dataset. Other embodiments of this aspect include corresponding computer systems, apparatus, and computer programs recorded on one or more computer storage devices, each configured to perform the actions of the methods.

Implementations may include one or more of the following features. The method as where the information may include: religious and spiritual experience and knowledge, spiritual beliefs and rituals, philosophy, ethnography, traditional cultural knowledge, social norms and practices, local environment, wilderness, farming, sustainable development. Creating the student curriculum may include: accessing a first content from Buddhist philosophy, Buddhist view, meditation and application, Buddhist ethics, rituals, ceremonies, prayers, customs, practices, shamata and vipassana meditation, deities practices, a transformational education approach, and a progressive education approach; accessing a second content from a philosophy, ethics, values, experiential, meditation, conduct, ceremonies, and rituals of the group; accessing a third content from rituals, ceremonies, and cultural knowledge of individuals in the group; accessing a fourth content from teaching methodologies of the group; accessing a fifth content from teaching methodologies of sustainable practices of the group; forming an ordered list by merging the first content with the second content, the third content, the fourth content, and the fifth content; and modifying the ordered list according to laws of the group to form the student curriculum. Creating the student curriculum may include: studying the group; creating lessons appropriate to an age of students, the lessons integrating ontology, epistemology, and a spiritual tradition of the group; and creating explanations of the lessons for the teachers. The method as may include: translating the teacher training dataset to a language of the group. The group may include: a culture, religious, or ethnic group. The transformational education approach may include: Waldorf education. The information may include: rituals, ceremonies, traditional cultural knowledge, and family values information categorized according to their relationship with contemplative science. Implementations of the described techniques may include hardware, a method or process, or computer software on a computer-accessible medium.

### BRIEF DESCRIPTION OF THE DRAWINGS

The present teachings will be more readily understood by reference to the following description, taken with the accompanying drawings, in which:

FIG. 1 is a flowchart of the overall methodology of the present teachings;

FIGS. 2A and 2B are schematic block diagrams of an implementation of the system of the present teachings;

FIGS. 3A and 3B present a flowchart of an implementation of the tagged target data processing of the present teachings;

FIGS. 4A and 4B present schematic block diagrams of an example of tagged target data processing of the present teachings;

FIGS. 5A and 5B present schematic block diagrams of an example of similarity target data processing of the present teachings.

FIG. 6 is a flowchart of an embodiment of a method in accordance with the present teachings; and

FIG. 7 is a flowchart of an embodiment of another method in accordance with the present teachings.

### DETAILED DESCRIPTION

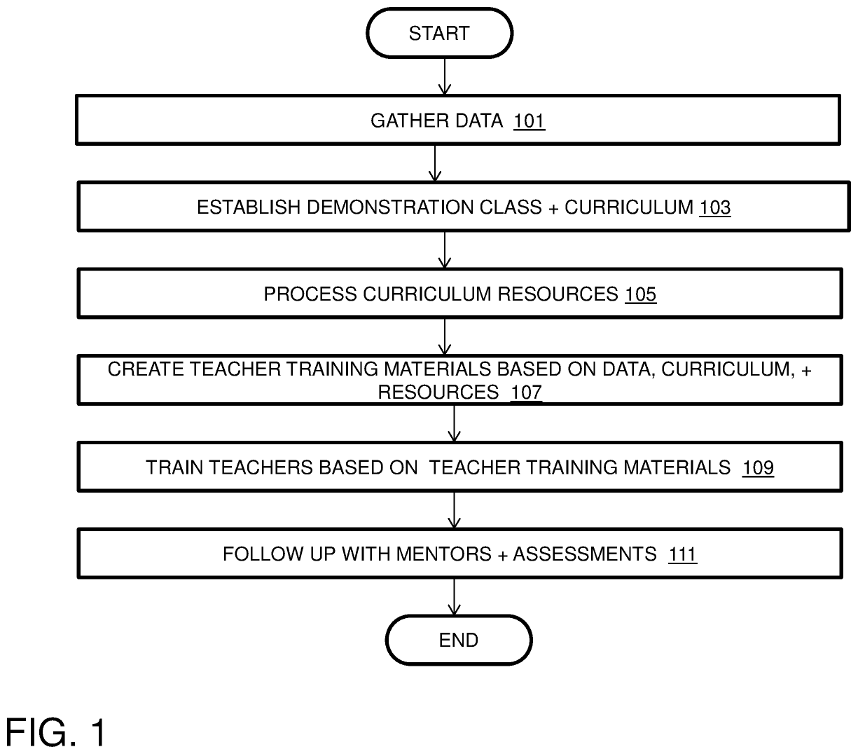

Referring now to FIGS. 1-5B, the system and method of the present teachings for developing a bespoke education program includes, but is not limited to including, collecting target data, for example, curriculum research and creation, creating the curriculum, creating teacher training materials based on the curriculum, training teachers, and assessing students. The curriculum can fuse, for example, live Buddhist experiential tradition which emphasizes applying wisdom and compassion in everyday experience, with Steiner/Waldorf education methodology and developmental science, and science giving rise to a new transformative experiential children's pedagogy. The present teachings contemplate other tradition and pedagogic pairings. The aim of system and method of the present teachings is to educate children towards inner freedom/liberation. The foundational experiential tradition and the pedagogy choice need to be transformative, experiential, and developmentally appropriate to support the child's being towards inner freedom to meet and nurture the child's all-round developmental needs.

The system and method of the present teachings enable the teacher to go beyond transmitting knowledge and facts to create a transformational approach to learning which is grounded in process rather than outcomes. It nurtures the child's changing consciousness and fosters autonomy and ownership in teachers. The system and method interlink the aspects of learning and knowing, and creates a curriculum that advocates for self-transformation by bringing about a shift in how children and teachers learn and experience the world, including internal and external shifts in consciousness and in their connections to selfhood, others and nature. In some configurations, Buddhist ontology and anthroposophical epistemology are combined to form the foundation for a learning and teaching methodology and curriculum. The outcome is an education approach that places the emphasis on developing wisdom and compassion that is to be lived in the class and in personal lives.

Choosing an ontology upon which to base curriculum and teacher training templates involves evaluating the aim of the ontology, the ethics, the psychology, the meditation practice, and the view of nature. Choosing a pedagogy involves evaluating the philosophy of education, child development theories and practices, education theories, and handling of the arts. For example, if Buddhism is the chosen ontology, the aim of Buddhism is to progress on the path towards liberation. The Buddhist view is vast and, in many ways, universal. It includes ethics, such as, loving kindness, compassion, non-violence, other before self and altruism. The Buddhist view of the nature of reality includes impermanence, or everything is constantly changing; everything is made of many parts that are interdependent or interconnected. Central to this view is that beings' true nature is pure, enlightened or all-goodness. The Waldorf/Steiner education system describes its philosophy of education and methodology, Steinerian psychology and epistemology; developmental science, developmental psychology and neuroscience, child development theories and practices, education theories and allopathic and holistic pediatric understanding of child development and human development, as well as various forms of arts, such as, visual arts, performing arts, modeling, sculpture, dance, music, singing, expressive arts, handwork and movement. These aspects inform the teacher training curriculum and methodology as well as the children's curricular content and learning approach from kindergarten to class 12.

An exemplary kindergarten curriculum template developed from exemplary Buddhist ontology and Waldorf pedagogy includes the following elements: the Buddhist year in season and nature, celebrating cultural festivals and contemplative practices, celebrating children's birthdays from the Buddhist view of human development, meditation with young children, integrated Buddhist view and ethics for the young child, nature studies and Buddhist ecology, the Buddhist circles, pre-literacy and numeracy and the Buddhist view, the bilingual language and dharma language, music and awareness, nature and awareness, being—as it is, an exemplary list of primary class curriculum elements includes, Buddhist imbued literature, cultural studies and literature, history and the Buddhist view, Buddhist and contemplative dances: cham (Tibetan), charya (Newar), eurythmy (Waldorf), drama, integrated earth sciences and the Buddhist view and meditation, integrated life sciences and the Buddhist view and meditation, integrated natural sciences and the Buddhist view and meditation, literacy and Buddhist ethics and meditation, numeracy, mathematics and Buddhist ethics and meditation, algebra, form drawing and geometry and awareness, sustainability studies and Buddhist ecology, teaching additional languages and Buddhist philosophy language, music and contemplation, Buddhist and contemplative science exploring awareness, compassion and wisdom and Buddhist ethics, bodhicitta (altruism), shamata (calm abiding) meditation, introduction to vipassana (insight) and analytical meditation, Buddhist prayers, recitation, short sadhanas (prayers and meditation) practice and simplified visualisation practices, Buddhist values, such as, motivation, aspiration, importance of lineage, guru devotion, paramitas, karma: purification and accumulating merit, introduction to Buddhist philosophy, performing arts, visual arts: painting, drawings, sculpture, modeling, Himalayan Buddhist arts, wood work and metal work, craft: traditional and contemporary, handwork, games, physical education, yoga and contemplative practices, information and communications technology (ICT), and, self-care, life skills and health and reproductive education.

Exemplary teacher training courses have six integrated components: foundation philosophical and meditative studies-teacher inner development, human development-child development from birth to rebirth, transformative experiential learning and teaching (children and adults) and teacher training methodology, transformative and experiential curriculum content and application, children's well-being, and school organization. With respect teacher inner development, teachers are anchored in the Buddhist worldview of nature of reality conceptually and experientially. The combination of daily philosophy classes taught in an experiential way, together with meditation and transformative and expressive arts, modeling, handwork and contemplative dance apply what was taught in the first part of the day to the lives of the trainees. With respect to child development, the trainees learn, from their courses, to understand the developing child from conception to birth to death and beyond and how it relates to the reasoning behind education of children. With respect to teacher training methodology, training is centered on self-transformation with a focus on bringing about a paradigm shift in how teachers learn, teach and experience the world. This type of teacher training gives equal weight to the intellectual (head) affective (heart), and action (doing) domains. Into the lessons in teacher training content delivery this methodology brings the head (theory, conceptual learning), heart (experiential (non-conceptual)-meditation, artistic expressions, contemplative practices) and doing (practical experiential using our senses and body-crafts, outdoor and nature based, arts). With respect to curriculum content, trainees receive the full curriculum content and are trained in how to teach using transformative, experiential, enquiry based and contemplative learning and teaching skills and tools. With respect to children's well-being, trainees are taught child observation, child study, child assessment, and writing reports. With respect to school organization, management, and community building, trainees are taught how to meet local government education requirements and other legalities while keeping the curriculum intact. Together, these six integrated components form the exemplary Buddhist contemplative education approach.

The method of the present teachings for developing a bespoke education system includes, but is not limited to including, identifying an ontology to develop the curriculum and teacher training templates, identifying a world view, identifying a pedagogy, gathering data from the target group related to the ontology and pedagogy, specifically the ontological view, mediation, prayers, rituals, philosophy, social norms and practices, and ecology, and the local ethnography, traditional cultural knowledge, local environment, wilderness, and farming. The method further includes developing a methodology and philosophy of the education system to include learning methodology and education approach resulting in curricula and teacher training.

An exemplary teacher training course requires four to six semesters of curriculum delivered over two to two to three years. The exemplary teacher training curriculum draws on Buddhist experiential tradition which emphasizes applying the knowledge acquired in everyday experience in order to nurture an ongoing transformation. Student teachers develop practical teaching skills based on child development theory and gain experience in creating teaching and learning resources in preparation for school placements and embarking on life as a teacher. The first semester is an exploration of the Buddhist worldview and practice through an experiential and transformative learning approach. Key philosophical principles are introduced and reinforced through meditation, dialogue and artistic hands-on activities. The emphasis is therefore on the integration and internalization of Buddhist philosophy so that it becomes part of the growth and flourishing of the student teacher's life. This section focuses also on the teacher trainee's inner development. During the first semester, the three main Buddhist vehicles or yanas are studied: Shravakayana or Foundational Vehicle, Mahayana and Vajrayana. Over several semester, each yana is presented from its own point of view, allowing participants to understand its beauty and integrity. Throughout the course, fundamental concepts such as pure nature or innate basic goodness, relative and ultimate truth, interdependence, emptiness, Buddha nature, skillful means and awareness and mindfulness, wisdom, joy, love and compassion are studied. The history of Buddhism is studied, touching on key texts, cosmology, and learning how to practice key meditations. In this process, the four main philosophical schools of Vaibhasika, Sautrantika, Yogacara and Madhyamaka are presented, explored and discussed. During the first semester, multiple modes of learning are provided. Lectures are balanced with significant time for meditation, interactive discussions, group processes, and creative and artistic activities. The Himalayan and transformative arts nurture an understanding of the metamorphosis of form through sculpting with wood and clay, the hidden qualities of color through painting and drawing, the transcendent qualities of sound through music and singing, language through speech and mantra recitation, and the understanding of space through movement and Charya dance (the dance of the mudras). Such insights go beyond the intellect and touch the realms of deep awareness and intuition. Still further in the first semester, the teacher trainees learn how to meditate using the Buddhist shamata and vipassana profound and creative practices. At the end of the semester, teacher trainees understand how to apply Buddhist meditation. The structure of the practice starts with refuge and bodhicitta, continues with the main meditation that is learned that day or week, and ends with dedication. This course engages in a path of awakening according to the stages of view, meditation and conduct.

In the second semester, the teacher trainees learn about the study of consciousness at the intersection of Buddhism, developmental science, Steiner and other holistic perspectives, develop child observation skills. and study learning theories. With respect to the study of consciousness, the teacher trainees develop an understanding of Buddhist human development, developmental science and the holistic Steinerian perspective of the nature of the human being. These modules explore physical, socio-emotional, cognitive, self and spiritual development from conception to birth, through childhood, adult development and the bardos of death. At the heart of this course is the Buddhist view of self and selflessness and emptiness. The teacher trainees explore what developmental science and Steinerian psychology have to contribute to this view.

The second semester covers the following topics: Module 1: The Intersection of Buddhism, Developmental Science, Contemplative Science and Holistic Perspectives on Human Development, Module 2: Early Childhood: Birth to Age 7, Module 3: Middle Childhood: Age 7 to 14, Module 4: Adolescence: Age 14 to 21, Module 5: Adult Development: Lifespan phases from 21 to old age, Module 6.1: From the Bardos of Death to the Moment of Conception, Module 6.2: Prenatal Development from Conception to the Moment of Birth, Module 7: Child Development, Biography Work and the Buddhist View.

In Module 1, the foundation is laid for holistic child development by establishing the Buddhist worldview from which to understand the nature of the human being from birth to rebirth. This provides the philosophical underpinning for the following modules. At the heart of this course is the Buddhist view of self and selflessness. Teacher trainees explore what developmental science and Steinerian psychology have to contribute to this view. The first section of this module focuses on introducing Buddhist psychology, developmental science and Steinerian/Waldorf views of the nature of reality as the foundation for holistic child development. The teacher trainees examine how they think about their thinking and how they know what they know. They look at how, in the attempt to answer these questions, they form the worldview from which they perceive and experience the world. They establish the Buddhist view of reality from which to understand the nature of the human being or human development. Nature of reality is explained as the two truths: relative truth as the understanding of interdependence, borrowing from Vaibashika, Sautantrika and Chittmatra Buddhist philosophical schools; and ultimate truth as the understanding of emptiness in Madhyamika. This lens provides the philosophical underpinning for the 8 modules.

In developmental science teacher trainees examine how meta theories, though invisible and unstated, drive their intellectual and scientific thinking. They examine how human development theories and studies, with different underlying meta theories, reach different answers to certain important questions. The Waldorf theory of human development emphasizes an unfolding of consciousness towards manifesting a full spiritual potential or inner freedom. When a person actualizes this potential, that person has reached a level where her thinking is motivated by ethical ideals or altruism. Steiner called this ethical individualism and saw it as the highest expression of human inner freedom. From a Buddhist perspective this can be related to developing a healthy sense of self. In Buddhism, the purest expression of bodhichitta or altruism goes beyond dualism, as boundless compassion for sentient beings. In the second section of this semester is an overview of the development of self from birth to rebirth from a Buddhist perspective and, nested within it, developmental science, contemplative science and Steinerian perspectives on the understanding of the evolving sense of self. The teacher trainees contemplate how a sense of self develops by engaging with the questions: How to understand the developing child in a way that it is possible to discern the process of becoming a person not trapped in the self? What tools does the teacher trainee have within that allows rediscovery of one's true nature? Buddhist psychology states the following aspects which taken together explain the evolving sense of self: Luminous self, healthy self (impermanence, interdependence and multiplicity) and unhealthy self (permanent, independent and singular); impermanence: subtle momentary impermanence and gross continuity impermanence; and the five aggregates, twelve links of dependent origination and the kleshas.

These themes form the threads or “touch points” that are woven through developmental science, contemplative science and Steinerian psychology in the other modules. Developmental science, as an interdisciplinary field, brings together multiple disciplines, such as psychology, sociology, anthropology, biology, neuroscience, and medicine, and contemplative science to try and understand how an individual becomes the person they become in time and space. The teacher trainees explore metaphors, equitable questions, and bridge ideas. Engaging with Steiner, the teacher trainee looks at the period from birth to death where Steiner suggested that human beings are essentially spiritual in nature. He highlighted that spiritual development evolves in conjunction with physical, emotional and cognitive development, and he described the influences and effects of biological, environmental and spiritual aspects on the individual's evolving consciousness. Steiner considered that the human being is a complex interconnected system comprising the physical body (form and matter) and three subtle energy systems (life force body, feeling body and Self or I body) that together form the vehicle of consciousness. The teacher trainee links this to Steiner's explanation that development proceeds from the natural awakening of the thinking, feeling and willing faculties resulting from the work of formative forces on the individual. In this way, at the intersection of Buddhism, developmental science, contemplative science and Steinerian psychology, the teacher trainee can explore the deep structures or backgrounds where shared assumptions are found. The teacher trainee takes a dialectical stance on the interpenetration of apparent contraries rather than establishing opposing views. In other words, the lens of the course is Buddhist (with contemporary explanation from contemplative science) and with that the trainees journey into developmental science and Steinerian psychology, letting each of the two fields describe human development as they are woven together within the Buddhist view or allow them to lie nested side by side, or within one another. In doing so, the foundation is laid from which to relate Buddhism, developmental science and Steinerian psychology to nurturing a holistic approach to child development.

With respect to Module 2, in order to become familiar with children's all-round development, this module offers an in-depth exploration of developmental science and Steinerian psychology and contemplative science and how these relate to and rest within the Buddhist view of human development. The teacher trainee learns about children's physical, socio-emotional, cognitive, self and spiritual consciousness, or development of consciousness, from birth to age 7. The Buddhist view on development of self interplays with developmental and Steinerian perspectives on the evolving sense of I. The teacher trainee also explores the relationship between body and mind. As the teacher trainee examines the main child development theories, they learn how to use this knowledge to observe children in different phases of early childhood, from birth to age 3 and age 4 to 7. Using the Buddhist paradigm as a lens, the teacher trainees begin their journey in understanding child development by examining the three selfs, the five aggregates and how they relate to the twelve links of dependent arising. In the unhealthy sense of self, the reality of constant change is confused with an appearance of permanence, composite parts with a singular identity, and interdependence with a controlling sense of independence. The healthy sense of self becomes aware of change, interdependence and multiplicity allowing glimpses of the luminous self. The teacher trainee explores how these three layers of self interact in the developing child from the perspective of developmental science and Steinerian psychology. Buddhist philosophy also contemplates progressive changes in the formation of the sense of self from birth to rebirth and we link the three I's, and the additional 2 I's as described by Tsoknyi Rinpoche, to explore this development, as well as the Buddhist view of body, speech and mind personality types. Resting in the Buddhist paradigm, the teacher trainee weaves socio-emotional and cognitive understanding of developmental theories, including but not limited to Freud, Erickson, Piaget, Bronfenbrenner, Gessel, Skinner, Kohlberg and Bowlby, and through all these the observation of the evolving sense of self is threaded. The teacher trainee also studies the biological aspects of developmental neuroscience and how these interact with the other domains of development leading to an understanding of how the sense of self is formed, and how the potential for awareness or consciousness can unfold. The teacher trainee explores how Steiner perceived the child as a holistic organism possessing an innate wisdom that guides and influences her evolution. This unfolding of sense of self and consciousness is affected by karmic inheritance, genetics and environmental factors and takes place at an individual pace according to each child's unique development needs. The teacher trainee studies Steiner's explanation of the evolving sense of self from birth to age 7. During this phase, the child's inner faculties are developed in conjunction with her physical body. The physical body's growth is driven by formative forces. For Steiner, this phase is centered on imitation, play, and physical activity and is characterized by the greatest physical growth of the stages. Physical development progresses gradually from the head downwards as the child gains increased voluntary control over her movements, learning to stand and walk, and organize speech and thinking. The child's consciousness, in contrast, develops from the feet up to the head, through doing (their will activities), feeling and then abstract thinking. The teacher trainee also reflects on Steiner's view on the fundamental virtues of reverence, gratitude, love and sense of inner duty. The Buddhist view of impermanence and constant change is woven through this module as the teacher trainee studies developmental science ideas of continuity and discontinuity and Steiner's metamorphosis of self. The teacher trainee can cultivate the deep knowing that things are changing constantly which we can then embrace rather than deny. The teacher trainee concludes this module by interlinking these three disciplines and how they are applied to support resilience building and the development of the healthy self (impermanence, interdependence and multiplicity or emptiness as nature of reality) that connects us to our pure nature of innate basic goodness.

With respect to Module 3, in this phase of childhood, the child's world expands and she develops subtlety of feeling. The healthy feeling life of the child is supported by providing a context of beauty for the things, from simple movements to complex ideas. By appealing to their natural imaginative capacities, children can be encouraged to use these active feelings to connect with learning as a process. During this period of childhood, the child becomes ready for academic learning, as long as it appeals to the social, physical and, particularly, to the feeling realms. In this module, the teacher trainee explores the development of thinking, feeling, and willing with a focus on feeling and pictorial mental image. This phase of childhood is subdivided into 7-8, 9-11 and 12-14 (puberty). In physical development, the teacher trainee examines variations in physique and motor skills. In cognitive development, the teacher trainee continues to explore Piaget's concrete operational thought, and perspectives on information processing and language. In psychological development, the teacher trainee considers emotions and emotional development. Psychosocial development includes social cognition, understanding others, understanding self, developing positive self-esteem, and the peer group. An important aspect of middle childhood is the society of children where friendship and social problem solving—the rejected, neglected or controversial child—become prominent. The teacher trainee studies the structure of emotions and their neurobiological nature in the development of wellbeing; the neuroscience of meditation and its application to education; research on mindfulness and the pre-frontal cortex, limbic system and brainstem; and the science of happiness and well-being. In this module, the teacher trainee continues to build the picture of human development anchored in the Buddhist view established in module 1. The following are the Buddhist touch points or threads that are woven with developmental science and Steinerian psychology: self: unhealthy self, healthy self and luminous self; impermanence: subtle momentary impermanence and gross continuity impermanence; the 5 aggregates, 12 links of dependent origination; the three i's and the additional 2 i's as described by Tsoknyi Rinpoche; Kleshas; and the body, speech and mind personality types.

With respect to Module 4, the lens of Steinerian psychology is used to explore the child's moving from the age of loving authority (ages 7-14) and coming into the age of reason, which provides the freedom for adolescents to develop their own thinking and balance in life (ages 14-21). In this phase, adolescents are ready to work with their thoughts and beliefs, to think critically and evaluate the world around them. Along with the adolescent search for knowledge, they also search for truth as they strive to make their lives their own. Steiner's understanding is that teaching through a sense of idealism and justice is essential for the health of the adolescent. Module 4 focuses on physical, cognitive, and psychosocial development, and self, self-identity, neuroscience, and adolescence. The picture of human development anchored in the Buddhist view is woven with developmental science and Steinerian psychology: self: unhealthy self, healthy self and luminous self; impermanence: subtle momentary impermanence and gross continuity impermanence; the 5 aggregates, 12 links of dependent origination; the three i's and the additional 2 i's as described by Tsoknyi Rinpoche; Kleshas; the Buddhist perspective on resilience and the body, speech and mind personality types.

With respect to Module 5, the end of adolescence marks the completion of a significant phase, but human development is a life-long process. Nourished with the Buddhist knowledge of human development, the landscape of adult development as part of lifespan science and the Steinerian phases of spiritual rhythms from 21 to old age are studied. Stages of life offer sets of challenges and lessons that enable the maturation process, providing opportunities for inner development and transformation. The changes that occur in consciousness or spiritual development and in the physical and psychological domains are studied. These changes may be steady or swift and may be positive, negative, or neutral. The complex interdependence of karma, physical, psychological, and environmental influences shapes adult development revealing a systems approach to human development. The way each 7-year cycle offers its own trials and encounters as well as the gifts of transformation, particularly the wisdom of accepting impermanence are studied, along with the interdependent nature of adult and child development. The understanding of adult development is dependent on knowing child development and how patterns acquired in childhood resurface as manifestations of healthy and unhealthy self.

Module 6 is divided into two parts—6.1 bardos of death to the moment of conception, and 6.2 prenatal development from conception until the moment of birth. In the previous four modules the bardo of living, the time from birth to the end of life, are studied. In module 6, human development focusing on the bardos of death is studied. As an important part of understanding child development from the Buddhist view of human development, the journey from the moment of death across the bardo of liberation, the bardo of becoming and back into the bardo of living at the moment of conception are studied. Bardo means intermediate or in-between. Experiences are part of one bardo or another, be it the bardo of living or the bardos of death. From a Buddhist perspective, it is incomplete to study human development without considering that this present life arises from previous life existence. Relative or samsaric (suffering life) existence is described in terms of: moment of conception, lifespan from birth to death, moment of death itself, and the state between two lives. The bardos are a natural consequence of the continuity of mindstream wandering in beginningless samsara through the six realms under the influence of confusion. The entire bardo of life (samsara) only ends when we rediscover our true nature. Teacher trainees are guided through experiential art exercises specifically designed to an experiential exploration of the bardo of liberation.

In the previous modules the bardo of living, the time from birth to the end of life and the bardos of death are studied. In module 6.2, the study of human development focusing on the prenatal phase of the bardo of life is studied. Prenatal development, the period from conception to birth, is studied here from physiological, epigenetic, psychological and Steinerian perspectives. From the Buddhist perspective, an explanation on the Buddhist prenatal development as taught in Nanda's Sutra and the Kalachakra Tantra (esoteric) is studied. Teacher trainees are guided through experiential art exercises specifically designed to an experiential exploration of prenatal development.

In Module 7, teacher trainees do biography work related to the phases of childhood. Experiential artistic exercises form an integral part of this work. Engaging with biography work enables participants to relate the approach of the present teachings with respect to child development to their own childhoods. This can be supportive on a personal level in progressing on the path of inner development and on a professional level in deepening the understanding of child development and its implications for teaching and caring for children. The aim of looking back at personal childhoods is to relate to child development through engaging with the trainee's life story and how it applies to who the trainee is currently. The aim is to help the trainee to understand him/herself better and integrate what the trainee has learned about this approach to child development, so the trainee can progress on the path towards rediscovering her/his true nature. In module 7, the trainee studies his/her childhood from within the Buddhist perspective of human development. In doing so, the trainee makes her/himself a personal study. Teacher trainees use their biographies to understand interdependence and interconnection between their childhood experiences and who they are right now. The task of doing biography is to awaken a living imagination of what it means to be human, and to develop an awareness of the laws and rhythms of biographical development. The trainees also explore the nature of human encounter as a foundation for the helping relationship. Biography aims to deepen self-knowledge and open a path of inner development that can heighten sensitivity and ethical awareness. Through this process the trainees have the opportunity to loosen the tightness of how they see reality and journey towards transformation and strengthening their healthy selves. When the trainees learn to read the script of their life stories, they begin to lift the veil and rediscover their true natures. The basic principle of working with the trainee's biography is dissecting the the outer experiences and looking at the inner feelings, thoughts and impulses that arose out of them. It is important not only for the trainee to work with our his/her biography but to also listen to others' biographies. Therefore, the trainees meet and listen to each other with reverence and interest so that they can get in touch with their real questions and potential.

The experiential Buddhist methodology that is part of an implementation of the present teachings includes Buddhist pedagogy, the transformative learning approach of Steiner, and contemporary progressive learning theories and methodologies. In this section of the teacher training course, the teacher trainees explore different learning theories and methodologies starting with the Buddha's three-fold qualities of wisdom, compassion and action and head, heart and doing; the methodology of Buddhist view, meditation and application; and the three wisdoms (prajnas) of hearing, contemplation and meditation. Taken together, they form a way for deepening the trainee's experience and making it more direct. Contemporary learning theories, such as Steiner/Waldorf, transformative learning, John Dewey progressive learning, Howard Gardener's multiple intelligences, progressive education which encompasses experiential, integrated and cooperative learning, inquiry-based learning, and others are woven together. The experiential Buddhist methodology theories and methodologies course has three components: (1) Buddhist and Contemplative Science learning and teaching methodologies together; (2) Steinerian learning and teaching approaches; (3) contemporary learning theories and methodologies.

In this course the teacher trainees explore three main views of learning theories and methodologies, starting with the Buddhist's three-fold qualities of wisdom, compassion and action and head, heart and doing; the methodology of Buddhist view, meditation and application; and the three wisdom or prajnas of hearing, contemplating and meditating. Taken together, they form a way for deepening our experience and making it more direct. Within this we weave Steiner's transformational learning, and other contemporary learning theories, such as, John Dewey, the progressive education which encompasses experiential, integrated and cooperative learning, inquiry-based learning, constructive learning, co-constructive learning and Howard Gardener's multiple intelligences. The training begin by studying the scholarly Buddhist learning methodology as originally practiced in the Nalanda tradition and these days in monastic colleges. At the heart of the Buddhist learning approach are the three aspects of: view (gaining conceptual understanding); meditation (gaining experiential understanding); application (implementing knowledge gained and experienced in our everyday life).

Interlinked with these learning approaches are the three learning stages: ground (linked with view), path (related to meditation), fruition (accomplishment, which also manifests in the way we conduct ourselves).

The trainees also explore the different teaching styles in Buddhism, that is, the Buddha style of teaching, and the arhat (a person who achieved self-actualization) and pandita (scholar) styles of teaching. Understanding the Buddhist learning and teaching approach is accompanied by studying Patrul Rinpoche's guidance as to what makes a good teacher, and what makes a good student.

Another component of this course is the Steinerian transformational learning approach. The trainees study in detail Steiner/Waldorf learning and teaching approaches for kindergarten and primary education. This includes Steiner's insights into the child's changing consciousness and how this knowledge is translated into pedagogy and used to nurture the child's inner development. This is interlinked with Steiner's threefold, fourfold and ninefold conceptions of the human being which are translated into a children's pedagogy towards inner freedom.

Yet another component of the course is the contemporary learning theories that have formed the progressive education approach. The trainees begin by studying the early innovators in education, such as Pestalozzi, Rousseau and Froebel and continue exploring the different contemporary theories that influence education today. The trainees continue by examining the complementary contemporary learning theories that came into being around the same time as the Steinerian approach: John Dewey, whose work forms one of the main pillars for progressive education, experiential learning, and integrated learning; Maria Montessori, who was also a contemporary of Steiner, brought innovation to early childhood learning approaches. Vygotsky, another contemporary of Steiner, looked at the zone of proximal development or the gap between what the students can do on their own, and what they can accomplish with the support of someone more knowledgeable about the activity. The trainees study Maslow' s hierarchy of needs theory which is widely referred to in education; Gregory Bateson's levels of learning; Albert Bandura's social learning theory, transformative learning theory; and Stephen Sterling's sustainable education theory. Howard Gardener's multiple intelligences have greatly informed education practices and are studied. More recently, Barbara Rogoff s learning theory focuses on the social and collaborative nature of learning and the various ways adults can guide children. Contemplative science learning methodology is also studied. The trainees focus on her work particularly relating to how children learn in traditional societies. Included in this course is also an overview of some of India's holistic education approaches. Education in South Asia has also been home to education innovators, such as Krishnamurti and Gandhi.

After the trainees have anchored themselves in these three distinct learning styles (Buddhist and Contemplative, Steinerian and Contemporary progressive education), they focus on how the Buddhist and Contemplative learning and teaching styles may relate to and translate into the Steinerian learning pedagogy of early and middle childhood. Having investigated the intersections between the Buddhist and Steinerian learning methodologies and objectives, the trainees then turn to the other contemporary progressive learning theories and methodologies and look for meeting points with the former methodologies. The Buddhist learning approach was designed for adults engaging in philosophical training. Steiner's transformative learning approach is aimed at educating the child towards inner freedom and his pedagogy rests on his spiritual path of inner development. Contemporary learning approaches, however progressive and wholesome they are, rest on a materialist paradigm. This creates tension between the aim of the Buddhist path to enlightenment (or self-actualization) and the materialist view which informs education theories and practices. In striving to answer the question of the purpose of educating children the trainees may arrive at three broad answers: (1) to produce workers that can compete in the marketplace, and develop a specialization in a field of work; (2) to educate children to grow up and act to make the world a better place through learning good citizenship, being able to question, enquire and think creatively, have social and ecological consciousness and act accordingly; (3) self-transformation towards inner liberation.

Furthermore, in line with Buddhism, the intention in the manner in which children are taught under the system and method of the present teachings is to nurture the development of awareness, compassion, wisdom and enlightened activities. Therefore, the aim of this course is to offer teacher trainees a broader understanding of learning theories as well as to enquire into the motivation behind each learning theory—what is the aspiration and motivation of the creator in designing such a learning approach? The teacher trainees examine how each learning theory can support or hinder the development of the child's consciousness towards inner freedom.

In another section of this course, the trainee studies the three pedagogical streams that form the experiential Buddhist learning and teaching approach or methodology. This synthesis is the process of translating and interpreting the Buddhist learning methodology into children's pedagogy through using the Steiner Waldorf transformative education approach and aspects of progressive education. The experiential Buddhist learning style can be described as a nested system that includes skills, enquiry and reflection, and self-transformation. The practical application of the experiential learning approach is in the teacher training curriculum and children's curriculum delivery or application of kindergarten to class 12 curriculum content as follow: being: experiential Buddhist foundation studies; teacher's inner development, view, meditation, application/conduct; knowing: human development from Buddhist, Steiner, developmental science, developmental psychology and developmental neuroscience perspectives; learning theories and approaches from Buddhist, Steinerian and other contemporary theories; learning: exemplary curriculum for kindergarten and primary (1-8) and secondary (7-12) education (class 1-12); living together with others: artistic disciplines, professional, organizational and social aspects of being an experiential Buddhism teacher for children; doing: bringing together handwork, craft, woodwork, metal work, stone carving with awareness meditation. also, practical competencies, such as teaching practice and practicum.

The transformative experiential education methodology and pedagogical application of the present teachings encompass and imbue: being, being as it is and as we are, awareness meditation, being in quietness, retreats, visualization and imagining related mediation practices, meditation in movement, prayers and recitation, ceremonies and rituals, awareness and mindfulness meditation, loving-kindness meditation, insight meditation, developing wisdom, analytical meditation, nature, grounding with nature and gardening/farming, “treading lightly on the earth”, “kissing” the earth, walking meditation, beholding with wonder and reverence, contemplative transformative arts and crafts, visual arts, sculpture and modeling, music and singing, storytelling and puppetry, sacred dance, mindfulness and handwork, quietness and centering with craft, movement, grounding with mindful movement forms, treading lightly on the earth, communion, closeness and connectedness, being of service to others, other before self, active listening, the art of conversation, personal development group gatherings, practicing non-judgmental attitude that rises from mind of bodhichitta (altruism), witnessing and opening a sacred space for oneself and others.

Semesters 2-4: Exemplary transformative experiential Buddhist primary (Class 8) and secondary (class 7-12) curriculum studies are described as follows.

The primary (class 1-8) and secondary (class 7-12) teacher training in the exemplary curriculum brings together Buddhism and Steiner/Waldorf methodology with the aim of offering both inclusive and transformational Buddhist content and learning processes. It emphasizes the cultivation and deepening of wisdom and compassion for personal and professional benefit. In line with Buddhism, Steiner/Waldorf education uses a paradigm centered on inner development towards freedom/liberation. The education system of the present teachings aims to nurture the development of heightened awareness in children and their connection to spirituality, nature, and other human beings. Steiner Waldorf education recognizes intelligence as a multifaceted human gift and quality, and how the mind is motivated, stimulated and awakened through the acquisition of knowledge. It also supports and enhances inspiration in artistic, moral and practical areas, while nurturing the teacher's own development and sense of responsibility.

This transformational teacher training places equal emphasis on engaging the head, heart, and doing in education. It combines emotional literacy (heart education) and a multi-sensory experiential approach to learning. Students also experience nature-based, artistic, contemplative and meditative practices for primary (Class 1-8) and secondary (Class 7-12) teaching.

A fundamental aspect of teacher training is understanding the purpose and practice of child observation. Students are introduced to observation by exploring the questions: What is observation? Why is it necessary? What is the difference between observation and interpretation? Child observation offers students the opportunity to practice and process what they have learned up to this point about child development. After repeated exercises in observation, students move on to child study. Trainees join a primary (Class 1-8) or a secondary (Class 7-12) classroom for two weeks as observers to complete their child observation assignment focusing on the following: physical appearance, movement, speech, language, social skills, and the senses (auditory, vestibular, proprioceptive, tactile, visual; and the integration of their input). This forms the basis from which trainees learn how to design individual plans, conduct child study, and write assessments, evaluations and end of year reports.

Trainees commence by receiving an overview of the exemplary curriculum for class 1-8 and class 7-12, which is imbued with the Buddhist view, meditation and application, and how this curriculum meets the child's cognitive, socio-emotional, spiritual, moral and inner development needs.

Trainees learn (in 2 separate courses) how to conduct primary (class 1-8) and secondary (class 7-12) lessons in 27 subjects and acquire the skills required to teach the subjects: integrated Buddhism studies (contemplative, experiential pedagogy, philosophy, rituals and prayers, meditation, Buddhist ethics, universal ethics, Bodhichitta (altruism) and more), meditation with children on a daily basis, contemplative practices, and literature, history and cultural studies, literacy and numeracy, mathematics, geometry and algebra, sciences (zoology, botany, physics, chemistry, mineralogy, geology, astronomy, geography, environmental sciences), additional languages, and how to teach a bilingual and trilingual class, music: playing musical instruments and singing, visual arts, performing arts, experiential arts and crafts: painting, drawings, modelling and sculpture; Himalayan Buddhist arts: Charya dance, thangka painting, paubha painting, mani stones carving, stone sculpturing, and wood carving, and metal work (such as statue making, and making rituals equipment and tools); crafts: knitting, sewing, crocheting, embroidery, woodwork, and metal work, sustainability education and Buddhist ecology, drama and class plays, cooking, gardening, nature studies, outdoor education, woodwork, bushcraft and Buddhist ecology, games (including cooperative and team games), yoga and movement, drama, self-care, life-skills, health and reproductive education.

In these subjects, trainees learn how to integrate experiential Buddhism and the Buddhist worldview, so that the learning experience is whole and, more importantly, supports progress on the path of inner development. In the subjects the Buddhist lens of joy, loving kindness, compassion, non-violence, precious human birth, impermanence, cause and effect, interdependence, dependent origination, motivation, awareness and mindfulness form the foundation from which the child learn to see and experience the world leading to acting in everyday life from such an understanding of reality.

The exemplary primary (class 1-8) and secondary (class 7-12) curriculum is taught in 2 to 6 week blocks over the school year, following the Waldorf learning framework. Trainees learn how to implement an experiential Buddhist curriculum using the system of daily and main lesson blocks, while ensuring the learning experience is integrative and transformational.

Trainees learn how to teach in a way that nourishes the child's development through storytelling, imaginative images, learning through doing, (and added in secondary school-learning through inquiry, logic and reasoning), and the arts. The art and craft of storytelling is a central teaching tool and students receive training in speech and storytelling and the art of reciting children's poetry and verses according to the child's developmental phase. Trainees learn how to make teaching and learning resources for class 1-12.

Trainees acquire knowledge and understanding on how to teach in a way that encourages in children the development of awareness and mindfulness, stimulates their imagination, intuition, and creativity, and develops their intellectual, inquiry, reasoning, artistic and practical potential. The experiential Buddhist curriculum includes shamatha and vipassana meditation, rituals and chants, Buddhist ethics, and basic concepts of the Buddhist view, such as, karma, interdependence, non-violence, joy, loving kindness and compassion, awareness and mindfulness which are integrated in the subjects, an throughout the child's school day.

Teacher trainees get first-hand experience of arts and crafts in order to nurture the realm of creativity that is linked with emotional well-being. Arts and crafts encourage the children's creativity to unfold and enable them to open up in a natural and safe way. Introducing Himalayan Buddhist arts brings a conscious understanding of the Buddhist and contemplative worldview and Himalayan culture and traditions. In paubha (tangkha) painting, for example, students learn to make natural mineral and plant pigments and to prepare a traditional canvas. In Charya dance, teacher trainees learn to build a different understanding of space, both outer space and their own inner meditative space, while continuing to develop a deeper understanding and recognition of the various Buddhist deities. In addition, students explore the transcendent qualities of sound through reciting the deity dance mantras and learning to sing Charya songs related to the dances.

Applied Buddhism in children's education (kindergarten to class 12): Deepening understanding of Buddhist Philosophy, this time engaging with classical texts; contemplative Himalayan and other Buddhist technology, Buddhist history, and using this lens of reality to engage and study natural sciences, humanities and social sciences. The following modules are in addition to the foundation of Buddhist thought taught in semester 1. They are interwoven into the curriculum studies section of the exemplary curriculum education informing the teacher training and children's curriculum. In this way the aim is at anchoring the trainees in the broader and deeper Buddhist perspective in understanding the subjects they will teach their students. The aim here is for the trainee to develop a deep connection and embodiment of the Buddhist view making it the lens from which they perceive and experience the world. Out of this an unspoken non-conceptual transmission can occur in that space between teacher and learner during lessons. Without the teacher's establishing stable knowledge and understanding of the Buddhist view and experience it will be difficult for them to teach a Buddhist based or contemplative based education.

Buddhist Philosophy: Deepening the understanding of the Buddhist view as the foundation for the exemplary curriculum's primary integrated Buddhist based curriculum for class 1-8: Deepening understanding of the Buddhist View through exploring classical Buddhist texts. These modules aim to support trainees in engaging with classical Buddhist text that is gently and experientially introduced into the upper primary curriculum class 6-8. These modules are interwoven into the curriculum studies anchoring the trainees in the broader and deeper understanding of topics they will teach their students. The aim here is for the trainee to develop a deep connection and embodiment of the textual content from which an unspoken non-conceptual transmission can occur when teaching to children elements of these texts in an imaginative, pictorial and experiential way. Without the teacher's establishing stable knowledge and understanding of the Buddhist view and experience it will be difficult for them to teach a Buddhist based education.

Essential teachings from Abhidharma: In this module, trainees study essential teachings from the Pali Suttas and Abhidharma literature: 4 noble truths; 5 skandhas; 4 seals: impermanence, suffering, non-self, and nirvana; Dependent origination: the twelve links of dependent origination; 8 consciousnesses.

Essential teachings on Buddhist Cosmology from Pali Suttas and Abhidharma Trainees also explore Buddhist cosmology from the Pali Agganna Sutta and Jamgon Kongtrul Rinpoche's The Treasury of Knowledge—Myriad Worlds.

Giving Rise to Bodhicitta: the affective-Intuitive elements of the Buddhist path/practice: the module focuses on the Shantideva's Way of the Bodhisattva text as well as 37 Practices of a Bodhisattva and Atisha on Lojon, and also focuses on practices of the heart as found in Indian Buddhism. This is linked to semester 1 foundation Buddhist thought modules, meditation practices taught throughout the training, as well as contemporary contemplative interpretations of such content. This content is linked to contemporary exploration of social and natural scientific explanations of affective experience, and contemplative pedagogies both within Buddhist and non-Buddhist frameworks. Trainees explore the Four Immeasurable, Bodhicitta and the six perfections and how it is applied in the exemplary primary and secondary curriculum for class 1-12.

Emptiness: Understanding True Reality: in this module, trainees will focus on Mahayana perspective of wisdom. Trainees cover both the Chittamatra and Madhyamaka philosophical schools that form the majority of the views found in Tibetan Buddhism. Training includes various contemporary interpretations of the Heart Sutra, Nagarjuna, Root Verses of the Middle Way, Atisha's A Lamp for the Path to Enlightenment and Tsongkhapa's Lam Rim Chenmo. Training explores central themes, such as, two truths, three natures, emptiness and the nine yanas.

Buddha Nature: Our Innate Enlightened Nature: this module continues to contemplate Buddha-nature as a continuation of building understanding of the foundations of Vajrayana. Trainees continue to engage with the Uttaratantra Shastra which was started in the Foundation studies semester.

Meditation and Prayers—Path: meditation: Contemplative Practices leading to Contemplative Primary Pedagogy. At the heart of the exemplary curriculum are meditation and contemplative practices for both teacher trainees and pupils. In the teacher training, over the course of two years the contemplative practices are linked and focused on the themes being discussed in philosophy and curriculum studies lessons. The intention of the daily meditation lessons is to ground the trainees' understanding in their lived experience. This includes Shamata (calm abiding) and Vipassana (insight meditation practices). Practices include: four foundations of mindfulness, reflective practices on the four noble truths, reflective practice on the four common preliminaries, Theravada inspired meditation practices of vipassana, analytical meditations focusing on emptiness and other meditative practices, contemplation and meditation on the paramitas, simplified sadhana practices which incorporate visualization and recitational practices, such as, Shakyamuni in view, meditation and shamata meditation, Avalokiteshvara meditation practice, White Tara in view and meditation, Medicine Buddha meditation practice with recitation, Manjushri in view, meditation and pedagogical application, Vajrasattva meditation practice, Guru Rinpoche practice: 7 lines prayer and a shower of blessings by Mipham Rinpoche.

Also included in this deepening study of the view and meditation are rituals: Daily offerings and the meaning behind them, understanding and reciting the five dedication prayers: trainees study the 5 different Buddhist dedication prayers. Trainees explore how to explain and what to recite with each year group from class 1-12. A short dedication can be recited at the end of morning practice and a longer one at the end of the day, such as, short and long dedication prayer, Buddha Maitreya dedication, King of aspiration Samantabhadracharya Pranidhana, aspiration from the way of the Bodhisattva, aspiration of Devachen and Aspiration of Buddha Akshobhya and Mahamudra aspiration

The Study of the History of Buddhism and pedagogical application for primary and secondary (class 1-12) history curriculum: Early Buddhism: In this module trainees reflect on the biography of Shakyamuni Buddha, the socio-political environment within which the Buddha was raised and his influences on Indian spirituality during and after his life. The world from which the Buddha emerged includes the Vedas and Upanishads, and Hindu epics, mythology and history before, during and after his life. King Ashoka who was instrumental in spreading Buddhism; the three councils and how the Buddhist teachings were standardized into a cannon over the first few hundred years after the Buddha's death; the emergence of the major Buddhist schools in the first few hundred years after the Buddha's death. This informs the primary and secondary school curriculum History studies content from class 1-12.

Buddhism from the beginning of the common era to the 12th century (Southern Buddhism): In this module trainees study the how Buddhism expanded and became diverse as it travelled: to Sri Lanka and Southeast Asia; to Central Asia (Pakistan, Afghanistan, and Iran); to China (and the silk road) and Korea and Japan. This module will inform the history and geography curriculum studies content for primary and secondary class 1-12.

How Buddhism formed in Tibet (Northern Buddhism): In this module, trainees study the various Buddhist masters arriving in Tibet, beginning in the seventh and eighth centuries, and continuing until the twentieth-first century. Trainees will explore how Buddhism was formed in Tibet, how it changed to arrive where it is today including the Rime movement of Tibetan Buddhism. This module informs the history and geography curriculum studies content for class 6-12.

The Exemplary children's curriculum for History includes the History of Buddhism (based on the above in-depth study) and world history. The study of world history is positioned, integrated, and taught from the Buddhist lens of cause and effect, impermanence and interdependence. In addition, History is taught not from a Eurocentric perspective.

Buddhism and Science for Primary and Secondary (class 1-12) Science Curriculum: Buddhism and science both strive to describe and understand the natural world. They both attempt to discover what is true and real, and to overcome confusion. They both employ methodology for investigation that are replicable. Science primarily describes the physical world and Buddhism primarily describes the world of the mind. In Exemplary Education, a sense is used that is based on a science approach/phenomenology where the senses are used to observe a phenomenon. Buddhism and science are fundamentally compatible because they are both committed to discovering true and correct understanding of how things are, and because both are based on causal reasoning. This means that things happen due to causes and conditions. The principle of interdependence is an important intersection of Buddhism and science. Outer interdependence is equivalent to a scientific perspective. Buddhism acknowledges that things appear, develop, and vanish due to causes and conditions, just like science does. In the exemplary science curriculum trainees foster an appreciation for interdependence by emphasizing it as a way to study science that is compatible with Buddhism. Science can be framed as a way to explore, describe and understand the world of outer interdependence. Buddhism does not go into as much detail as science in this area, because general principles are sufficient for its aims, which are understanding suffering, letting go of its causes, realizing inner peace/wisdom/emptiness and cultivating the path. But Buddhism has a very rich description and understanding of inner interdependence, which science has not developed. Inner interdependence is the world of mental karma, virtue and non-virtue, stages of meditation, connection of mind states to the six realms, samsara and nirvana, liberation and enlightenment.

Science in its true essence is a method, a process, an evolving set of observations and knowledge. Science is a tool to explore the natural world around us, and in its pure form is open to any possibility and theory. In the exemplary curriculum trainees distinguish between science as a method and scientism as a rigid belief system. Science, as a process with a spirit of discovery, and openness and its evolving understanding, is not opposed to Buddhism. It is complementary to Buddhism, as it continually investigates and discovers more and more accurate understanding of the physical world around us.

If the view of mind-as-primary is introduced early on, then the materialist theories and observations of science occupy a place within that view, which is the description of physical reality. Otherwise, if materialist science is taught first, in a way of matter-as-primary, it can develop the other way round.

Waldorf education emphasizes a sense-based approach to learning, instead of abstract concept-based approach. This is in accord with Abhidharma or Buddhist psychology, which emphasise the experiential approach, i.e. discovering reality through sense experience and describing what can be observed and experienced through our senses in normal modes of perception, as well as meditative states of focus and concentration. These observations and models, such as, dependent origination, the 12 links, the five elements, the 5 aggregates, the 8 consciousnesses and so on, are both a model of the world-of-experience, and a guide to help explore deeper Buddhist principles such as impermanence, interdependence, multiplicity, the truth of suffering and cessation of suffering, not-self, emptiness, liberation, and dualistic versus nondual awareness.

In general, science can be taught in a sense-based or concept-based way. In the exemplary curriculum science is taught from the sense-based way as encouraged in Waldorf education and Buddhism because it is connected to transformative experiential learning, wonder, and participation. This is an essential building block of transformative experiential Buddhist learning. If a concept-based or model-based approach is used then this promotes the idea of a purely mechanistic world, where some behind-the-scenes laws are governing everything, then the world is like a machine, which has a front that we can see, and has a mechanistic ‘back’ that determines everything regardless of our experience as observers. The universe is dry and mechanistic, and this feels deterministic. This is a non-participatory way to view the universe, and isolates our conceptual thinking from our embodied senses as the primary way to explore and understand the world around us. The sense-based approach is less obsessed with the models, and instead promotes a curiosity and sense of discovery, where sense experience and cognitive understanding go hand in hand and inform each other.

On subjectivity and objectivity issues: Buddhism is founded on a subjective (experience-first) approach to analyzing and understanding the world around us. Pure objectivity is possibly not accepted by Buddhism, except in perhaps the case of partless particles in Shravakayana Buddhist philosophy. Although even in Sautrantika, these are never directly experienced and cannot be confirmed by the senses, as our experience is a mental image. Science, with its evidence based, experimental approach to developing knowledge, is much more interested in objectivity, and often assumes it. Although in contemporary quantum physics breaks, the notion of pure objectivity breaks down (Heisenberg's Uncertainty principle), in much more classic physics and science, the notion of objectivity is assumed.

At the heart of the Exemplary Science curriculum Buddhism and science share a respect and compassion for life and an appreciation of our natural curiosity. We foster in the pupils a natural curiosity and love for all living things; children, adults, animals on the ground, animals in the water and animals in the sky, tiny insects and plants. Seeing and creating beautiful images of animals and plants and learning about the ecosystems and eco diversity encourages a child's natural love for the earth and for all creatures. Through imbuing the teaching of the science curriculum with the Buddhist attitudes of wonder, appreciation, and wish to protect the earth and its living creatures we nurture in learners to further develop natural capacities of awareness, love, compassion, curiosity and insight/wisdom.

The Exemplary Science curriculum is taught as a development of ideas expressed in the first two Buddhist schools of Vaibhasika and Sauntrantika. For example, the atomic particle view of physics before quantum mechanics is somewhat similar to certain Vaibhasika ideas. Suatrantika describes the process of perception similar to high school level Biology, although this can be presented in simple forms to even younger children. Yogacara and madhyamaka philosophy make more subtle points, but do have correlations with some more modern scientific understandings, such as quantum physics, relativity theory, and neuroscience. This is advanced Buddhism and science, and is introduced at secondary school level study in a seed form through metaphor and open questions and continuing through enquiry, logic, and reasoning.

Both science and Buddhism describe with a wish to understand the natural world; what is true and real. Both want to overcome confusion. Science primarily describes the physical world and Buddhism primarily the world of the mind. They are fundamentally compatible not because they agree on everything but because they are both committed to true understanding and because they are both based on cause and effect.

Buddhism is comfortable with cause and effect and therefore, it can be taught in dialogue with science. There are strands of science now that employ a view of Interdependence, Impermanence and Multiplicity to embark on investigations and so interdependence can be seen here as key in bringing Buddhism and science together in our primary science curriculum. The details of the process science describe but Buddhism acknowledges the process. In the Exemplary science curriculum, we engage with science from the Buddhist lens of understanding reality. Therefore, science is seen as part of Buddhism and is seen as an activity, a process, a way to analyze and gather information. The Buddhist continuity of consciousness or mind is primary versus matter being primary. Buddhism is about working with the mind and liberation. Motivation of Buddhism and science are not the same and the results are not the same. The interest of each other is not the same/Buddhism steps back; its all about interdependence, emptiness. Science is about measuring and describing minute details. Science is interested in details. The Exemplary science curriculum is taught in an integrated way through the sense-based approach employed in Waldorf pedagogy and anchored in Abhidharma and other Buddhist perspectives of understanding reality. As a second stage, in the last years of primary and in secondary education conceptual abstract aspects of science can be brought in. In the younger grades, we lay the Buddhist foundation for teaching secondary school science curriculum by introducing to the children basic concepts of cause and effect, interdependence and impermanence. For example, we link in the curriculum class 3 Nature Science and farming and class 5 Botany with the Pali tradition and abhidharma's understanding of cause and effect-karma. We also teach it from the view of interdependence and impermanence (subtle momentary continuous changes and gross change). Observing various phenomena that are related to causes and conditions for something to happen, not happen or for certain changes to occur.

In the Exemplary social science curriculum the theme of people and occupation with an emphasis on the perspective of interdependence and other before self is explored. The work that is done is for others, for example, a farmer grows food primarily for others to consume. Ethics such as being a contributor in society are linked with the paramitas (the 6 virtues) and that everything is interconnected and nothing has an intrinsic self. Another example from the Exemplary curriculum is bringing together Buddhism and science is in Zoology. In the exemplary curriculum, trainees are introduced to animal studies together with the preciousness of all lives—that animals have consciousness and they equally feel pain and have the same wish to be happy and to be free from suffering. Therefore, non-violence, love, kindness, compassion, karma, and reincarnation are an integral part of zoology studies. In the Metta sutra the Buddha said that just as a mother protects with her life her child so with boundless heart, all living beings should be cared for and protected. When ecosystem and eco diversity are explored in relations to animals and their habitat it is taught from interdependence, perspective. Abhidharma (represent the constant structure of human psychology) and sense base science and scientific enquiry are brought together as the five skhandas (Form/matter Feeling/sensation; Perception/conception; Samskara/mental formations; Consciousness-consciousnesses/senses) manifestation in animals and human beings are observed as well as the similarities and differences to appreciate the precious human birth and our responsibility towards all sentient beings.

An example of transformative experiential Buddhist science curriculum of teaching physics: In the physics curriculum acoustics, optics, magnetism, heat, together with the fundamentals of Abhidharma are taught: skandhas; consciousnesses; twelve ayatanas or 12 sources of consciousness or bases of cognition. Children are helped to understand that the 18 dhatus or elements or knowable things are related to the world in an interdependent way. The eighteen dhatus are the classification of the knowable things into eighteen elements: the six objects or visible forms: sounds, smells, tastes, textures, mental objects; the six sense faculties or organs: eye faculty, ear faculty, nose faculty, tongue faculty, body faculty, mental faculty; the six consciousnesses: eye consciousness, ear consciousness, nose consciousness, tongue consciousness, body consciousness, mind consciousness; in addition, the following aspects of Buddhist worldview is taught in the science curriculum: Perception—physics; Transforming harmful emotions, non-violence-zoology; Empathy and compassions-zoology; Buddha Nature—zoology; Mindful intention—sense based science; Interdependence/interconnection—chemistry, botany, geology, astronomy sciences; impermanence and change, cause and effect—chemistry, botany, geology, astronomy. In the understanding of the Buddhist view there is an element of understanding or explaining reality that is linked with awareness, loving kindness and compassion and insight. In this way, teaching science in the approach is not only anchored in the Buddhist view of reality but also in contemplative practices.

The physics curriculum of teaching sound, light, colour, heat, magnetism and electricity are begun by first anchoring the children in Abhidharma. In Abhidharma form, sound, smell, taste, sensation and the sixth consciousness, which is the conceptual or mental mind, are introduced. Abhidharma explains that there are 6 objects outside; 6 organs in between; and 6 consciousness inside. It is introduced to the children how these three aspects interact with one another and describe to the children the nature of each aspect. In Buddhism there are three aspects linked with sound: there is the object, the organ and the consciousness that listens to the sound. In Buddhism as in physics sound travels, reaches the ear: ear—organ, vibration—object, the act of hearing—consciousness.

The act of hearing is the consciousness that listens to the sound. Sound travels, it is impermanent and changing. It comes to the ear organ; the mind understands the sound when the sound vibrations touch the ear organ. Sound in itself has no meaning. When the experiential element through sound meditation is introduced, the sound changes depending on one's state of mind: if one is happy, the sound sounds pleasant. If one is unhappy, the sound does not feel pleasant. Choose a sound or a piece of music and ask each pupil what they feel about it. Once sound—but some pupils will like the music, some might find it neutral and some will not like it. This is because each one has their own perception. Next is exploring the interdependence between the mind consciousness: the ear organ and the vibration but the specific perception depends on each individual consciousness. The sound itself is the same, but when the mind consciousness (6th consciousness) perceives it, then depending on the perceiver the sound will be experienced as pleasant, unpleasant and neutral. Investigating together with the children by looking inward is desired. Whether sound is pleasant, unpleasant or neutral depends on the mind as it judges the external phenomenon which is experienced through our senses. Different sounds are explored with the children and they are asked to be aware of how that sound makes them feel. An unpleasant sound causes suffering, a pleasant sound causes those who hear it to feel good—it is worked towards the children's understanding that the mind judges sound. It is the 6th consciousness that makes the projections about the sound. The sound itself has no meaning. The sound bothers one student but it doesn't bother another student. By understanding that, one's interpretation of sound is perceived and used for further understanding of each other. Each person perceives things differently or experiences things differently. This can help understanding others and with that develop compassion. This idea is explored with the children and reflect together with them.

In the last year of primary, in class 8 this topic is returned to through biology and the study of the human body with a focus on the human voice and the organs required for us to produce sound and speech. Tantric (esoteric) Buddhism explains the process a human being goes through to develop communication and articulation: it explains the gross body aspects of prana, bindhu and nadi as explained also in Tibetan medicine. Prana is energy; Nadis are the nerves; and bindu are the cells. The nerves and the cells are connected by the mind or moving energy. The body is fully formed because of the movement between the Bindu and Nadi. The wind energy is important. At first children want to speak. The mind influences the energy, the wind and the mind try to influence the cells and create new special paths and try to connect to one another. Cells form as letters; cells form as language; cells form as pattern. The human voice is impermanent and interdependent (tongue, palate, breath, throat opening and closing, these need to work and be combined together for sound to be produced.

When the students are anchored in the Buddhist view and meditation linked with Abhidharma about consciousness relating to sound, basic acoustic phenomena are introduced (vibration, pitch, volume, tone color); beginning with familiar musical instruments, pupils can recognize vibration as the physical equivalent of tone; the connection of the sounding body to volume; intervals on the monochord; sound transmission; resonance. Chladni plates; rotating plate with holes and air jet; sound directing; Echoes.

Transformative Experiential Buddhist/Contemplative Education Kindergarten Teacher Training Course Content: Each semester consists of block teachings of 1 to 20 weeks each, such as, Child Development, Foundation Buddhist or Contemplative Studies, Curriculum Studies. In addition, each semester includes ongoing classes, such as, meditation, arts, handwork, personal development and movement.

Semester 1 (Winter/Spring): Transformative Experiential Buddhist Foundation Studies; Duration: 14 -16 weeks online classes+2 reading week: Induction and Introduction to Buddhism, Buddhist philosophy: Shravakayana, Buddhist philosophy: Mahayana; (1) Buddhist philosophy: Vajrayana; (2) Karma and biography work; (3) Understanding and practicing Buddhist meditation: Shamata meditation; (4) Understanding and practicing Buddhism: rituals and the four thoughts; (5) Introduction to observation and awareness meditation; (6) Himalayan Buddhist arts; (7) Handwork and mindfulness; (8) Transformative experiential arts related to Buddhist view and philosophy; (9) Personal development group; (10) Music and singing; (11) Arts and crafts and mindfulness and the science of the heart.

Semester 2 (Summer/Autumn): Human Development-Child Development from Birth to Rebirth: The study of consciousness at the intersection of Buddhism, developmental science and holistic perspectives; Developing Child Observation Skills using awareness meditation and Steinerian observation skills (Goethean science); The Buddhist perspective on the Temperaments and the Ecology and. Physiology of the Senses/Consciousness in View, Meditation and Pedagogical Application; Learning theories: Buddhist pedagogy, the transformative learning approach of Rudolf Steiner and other contemporary learning theories leading to the understanding of transformative experiential Buddhist pedagogical approach; Transformative Experiential Buddhist Kindergarten Curriculum Studies; Duration: 19 weeks online classes+2 weeks child observation placement+3 reading weeks: (1) Human Development—Child development from birth to rebirth: The study of consciousness at the intersection of Buddhism, developmental science and holistic perspectives;: (a) Module 1: The intersection of Buddhism, developmental science and holistic perspectives on human development; (b) Module 2: Early childhood: Birth to age 7 from a Buddhist, developmental science and holistic perspectives; (c) Module 3: Middle childhood: Age 7 to 14 from a Buddhist, developmental science and holistic perspectives; (2) Introduction to observation, awareness meditation and the practice of child observation; (3) Child observation practicum (in student's own country); (4) Learning theories: Buddhist pedagogy, the transformative learning approach of Steiner and other contemporary learning theories leading to the understanding of transformative experiential Buddhist pedagogical approach; (5) The Buddhist perspective on the Temperaments and the Ecology and Physiology of the Senses/Consciousness in View, Meditation and Pedagogical Application; (6) transformative experiential Buddhist kindergarten curriculum studies: (7) Transformative experiential Buddhist kindergarten curriculum overview; (8) the Buddhist kindergarten day towards a bilingual classroom: balancing mother tongue and additional languages, introducing dharma and contemplative language music and singing; (9) transformative experiential kindergarten curriculum: (a) rhythm of the day and week; (b) working with the rhythm of nature's seasons; (c) understanding each activity of the day: free play, choice, outdoor play, nature walks, crafts, storytelling, circle time; (d) the kindergarten environment; (10) transformative experiential kindergarten curriculum: (a) making nature friendly teaching and learning resources; (b) making nature friendly toys; (11) transformative experiential kindergarten curriculum: woodwork with the kindergarten child; (12) Deepening the understanding and practice of Buddhist meditation for teachers; (13) Himalayan Buddhist arts; (14) Transformative experiential arts related to child development; (15) Handwork and mindfulness; (16) Personal development group: Weekly discussion and group reflective practice; (17) Reading weeks/self study/writing assignments; (18) Arts and crafts and mindfulness and the science of the heart.

Semester 3 (Winter/Spring): Child Development and Transformative Experiential Buddhist Kindergarten Curriculum Studies; Duration: 19 weeks online classes+2 weeks teaching placement+2 reading weeks: (1) transformative experiential Buddhist kindergarten curriculum: the art and craft of storytelling in pedagogy; age appropriate stories for kindergarten; nature stories, folktales and fairytales-common to the stories-ahimsa, tread lightly on the earth, interdependence, karma, impermanence. (2) transformative experiential Buddhist kindergarten curriculum: the Buddhist Year: yearly, monthly, weekly, and daily; special occasions; (3) transformative experiential kindergarten curriculum Studies: creating kindergarten learning environment; (4) Child development from birth to rebirth: The study of consciousness at the intersection of Buddhism, developmental science and holistic perspectives: (a) Module 4: Adolescence, age 14 to 21 from a Buddhist, developmental science and holistic perspectives: (b) Module 5: Adult development, 21 to old age from a Buddhist, developmental science and holistic perspectives: lifespan phases; (c) Module 6.1: From the bardos of death to the moment of conception; (d) Module 6.2: Prenatal development from conception to the moment of birth from a Buddhist, Developmental science and holistic perspectives; (e) Module 7: Child development, biography work and the Buddhist view; (5) transformative experiential kindergarten curriculum: (a) Making nature friendly teaching and learning resources; (b) Making nature friendly toys; (6) transformative experiential kindergarten curriculum Studies: teaching spoken English as additional language; (7) Meditation for teachers in relation to pedagogy, and teaching and being with children; (8) Contemplation and meditation on the paramitas in relation to pedagogy and working with children; (9) From child observation to child study: a contemplative practice; (10) Musical instruments and singing for kindergarten; (11) Handwork and awareness meditation; (12) Arts and crafts and mindfulness and the science of the heart; (13) Practicum: teaching placement at a kindergarten; (14) Reading weeks/self study/writing assignments.

Semester 4 (Summer/Autumn): Transformative Experiential Kindergarten Curriculum Studies; From an Unhealthy Self Towards a Healthy Self: Safeguarding and Nurturing the Wellbeing of Children with Buddhism in Mind; The compassionate wholesome practice of school organization, management and community building; Duration: 16 weeks online classes+4 weeks teaching placement+2 weeks reading weeks+2 weeks Independent Studies/Project: (1) transformative experiential kindergarten curriculum studies: (a) the Buddhist year: yearly, monthly, weekly, and daily; special occasions; (b) Transformative experiential Buddhism for kindergarten in View; (c) Experiential Buddhism for kindergarten: meditation with young children; (d) The Buddhist year in different Buddhist traditions; (2) transformative experiential kindergarten curriculum studies: The craft of the Buddhist year; (3) transformative experiential kindergarten curriculum studies: The arts and crafts of puppetry; (4) transformative experiential kindergarten curriculum studies: arts and crafts activities with young children and their relation to holistic child development (watercolor painting, drawing, sewing, wool, finger knitting, paper craft, nature craft); (5) transformative experiential kindergarten curriculum studies: teaching spoken English as additional language; (6) transformative experiential kindergarten curriculum studies: the kindergarten pre-literacy and numeracy curriculum and its creative application; (7) transformative experiential kindergarten curriculum studies: Musical instruments for the kindergarten and singing: Inner development of teacher: Vajrasattva Meditation for teachers; (8) From an unhealthy self towards a healthy self: Safeguarding and nurturing the wellbeing of children; (9) The compassionate wholesome practice of school organisation, management and community building; (10) Meeting local government education requirements; (11) Child study and child assessment and writing reports; (12) Charya Dance; (13) Arts and crafts and mindfulness and the science of the heart; (14) Practicum: teaching placement at a kindergarten; (15) Personal Development Group: Reflective practice.

Students Assessment: (1) Students are assessed throughout the course on the basis of: attendance, active class participation, tutorials, written assignments, oral presentations, reflective practice, observation exercises, curriculum planning and preparation of teaching activities. (2) Students are required to successfully complete all assignments. (3) Students are required to attend 80% of all course classes. (4) Practicum /practice teaching: (a) In semesters 3-4, students will practice teaching at a kindergarten of their choice. During each teaching placement students will be expected to write a reflective journal, keep a record of class plans, and be assessed by a tutor. (b) During semester 4, practicum students are expected to lead a kindergarten class for a week or more and be assessed on their ability to manage all aspects of running a kindergarten day.

Teacher Training Outcomes: Trainees attend courses in semesters 1-4. The objective of the training is to prepare teachers and aspiring teachers to become transformative experiential Buddhist kindergarten teachers. Training graduates are given additional tools to be able to take senior teaching positions and education leadership roles. The expected learning outcomes are the following: (1) Graduates will have a solid foundation in Buddhist view (philosophy) and experience (meditation) from which to apply kindergarten education within a Buddhist paradigm. (2) Graduates will have gained a strong understanding of child development from Buddhist and other perspectives of human development, including developmental science, and in their work with children. (3) Graduates will be able to teach a transformative experiential Buddhist kindergarten curriculum in which secular subjects are imbued with the Buddhist view, meditation and everyday application. (4) Graduates will be able to teach transformative experiential Buddhist kindergarten curriculum in different settings such as: Buddhist and contemplative based schools around the world; Buddhist and contemplative communities and dharma centers; schools in the Himalayan region; and monastic schools. (5) Graduates will apply knowledge and practice of the Steiner/Waldorf kindergarten approach in a context of Buddhist education.

Purpose of these training courses: Teacher training is open to teachers and aspiring teachers who wish to bring Buddhist-imbued content and Waldorf/Steinerian pedagogy, combined with insights from developmental neuroscience and psychology, into their teaching practice. Our training is particularly suitable for those who wish to: (1) teach in existing Buddhist contemplative based kindergartens, primary or secondary schools around the world; (2) teach at an education program associated with Buddhist or contemplative centers around the world; (3) set up a Buddhist or contemplative based kindergarten, primary or secondary school; (4) set up an education program for Buddhist or contemplative based centers around the world; (5) teach in Buddhist monastic schools.

Curriculum Development Template for the different Buddhist Traditions (Theravada, Mahayana, Vajrayana) and cultural background, and non-Buddhist communities. The training and curriculum content is designed to be adapted to any Buddhist community around the world. Also included in training is how the Buddhist content can be mostly taught in a contemplative way (secular) for non-Buddhist or mixed Buddhist and non-Buddhist school communities. This training can greatly support teachers teaching in progressive and contemplative based schools around the world; for those who teach children dharma holiday camps and in dharma centers around the world as well as Buddhist monastic schools and Buddhist based lay schools in Asia.

The right education at the right time using the right approach that takes into consideration the developing child and how they learn in each phase of development can make a difference to how the child receives knowledge and whether this brings healing or becomes detrimental or a hindrance to the child's well-being.

A Template for Developing a Bespoke Transformative Experiential Education for Specific Communities' Cultural and Spiritual Heritage—Buddhist and Non-Buddhist Communities using Buddhist or Contemplative Science:

The Process of Developing a Bespoke Transformative Experiential Education:

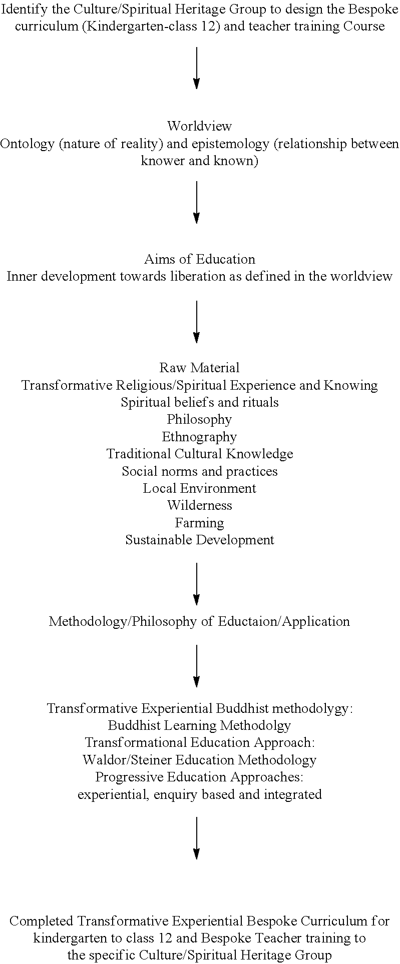

Transformative Experiential Buddhist Primary Curriculum for class 1-8 and Secondary Curriculum class 7-12: Detailed explanation of the stages for developing a bespoke Transformative Experiential (Contemplative/Buddhist) Education Program: (1) Stage 1: Curriculum Research and Creation: the research team will base itself in that area, researching, living, learning, and absorbing as much as possible from the community, culture, and religious life. This will be an important aspect aiding in the creation of a curriculum that is true to the local culture. The research team will collaborate with the school, working closely with the kindergarten, primary and secondary teachers to establish the demonstration kindergarten, primary school and curriculum. The next step will be to establish the secondary section of the school. Based on field and literature research, lessons appropriate to the kindergarten, primary and secondary school level will be created. These lessons will interweave ontology, epistemology and the specific religion/spiritual tradition worldview or paradigm. Together Human development/Child development that takes into consideration the specific culture's spiritual/philosophical heritage on human development, all of which are merged with the local culture, festivals, religion, and traditions. Included are detailed explanations to teachers in order to clarify the implementation of the lesson, as well as to enrich the teacher's knowledge about the lesson content. The curriculum is designed by incorporating Theravada, Mahayana and Vajrayana and transformative education into the local cultural setting. Indication of the Waldorf educational approach can be used as the vehicle to integrate Buddhism together with Sustainable development. Local cultures may be absorbed into the Waldorf educational principals that is imbued with Buddhist wisdom. Waldorf education provides flexibility, and the philosophy behind this educational approach blends well with Buddhist values and practices, indigenous belief systems, and local culture and be able to contribute to the existing education system.

Creating the Curriculum: Step 1 Conduct Research: (1) Buddhist research: Textual; (2) Local culture research: (a) Religious study: study the group's spirituality and religion: philosophy, ethics, values, ceremonies and rituals, understanding of human development and nature of reality. Study all this in relations to contemplative science and Buddhist universal values and weave together; (b) Ethnography: rituals and ceremonies, traditional cultural knowledge, family values and other traditional family values. Weave together with contemplative science; (c) Is there a specific traditional learning methodology that the studied group uses in teaching children or adults. (3) Sustainable development: Using sustainable development criteria (economic, social and environmental aspects relating to ecology and sustainability), pull out of the ethnography and religious/spirituality studies of the group values and practices traditional practices, such as, green energy, minimizing waste or waste management including sanitation, buying locally, recycling, vegetarian diet organic if possible, using equipment and resources made of natural materials, and using materials that are not polluting the environment. In this section traditional knowledge of the group sustainable practices that can be included in the curriculum are studied. (4) Study the local group's government requirements for education in order to adjust and find solutions to meeting ministry of education legal requirements while at the same time keeping true to the approach of the present teachings.

Step 2: Using data or raw material collected and processing it through the methodology and Waldorf pedagogy together to create the curriculum content for each year group from kindergarten to class 12. The curriculum rests on the combined group's worldview and the contemplative worldview, human development, and learning methodology.

Kindergarten curriculum content: (1) Transformative experiential Contemplative Kindergarten Curriculum components; (2) The Buddhist year in rituals, prayers, and celebrating auspicious Buddhist days; (3) The Buddhist year in season and nature; (4) Celebrating cultural festivals and contemplative practices; (5) Celebrating children's birthdays from the Buddhist view of human development; (6) Meditation with young children; (7) Integrated Buddhist view and ethics for the young child; (8) Nature studies and Buddhist ecology; (9) The Buddhist circle; (10) Pre-literacy and numeracy and the Buddhist view; (11) The Bilingual language and dharma language; (12) Music and Awareness; (13) Nature and awareness; (14) Being—As It Is.

Transformative Experiential Buddhist Primary Curriculum Content for class 1-8 and Secondary Curriculum Content for class 7-12: (1) Buddhist imbued literature; (2) Social Science Cultural Studies and literature; (3) History and the Buddhist view; (4) Buddhist history; (5) Buddhist philosophy; (6) Buddhist and contemplative dances: Cham (Tibetan), Charya (Newar), Eurythmy (Waldorf); (7) Drama (Buddhist related; contemplative related and cultural related|); (8) Earth Sciences (geography, geology, mineralogy, astrology, environmental studies, sustainability studies) and the Buddhist view and meditation; (9) Life sciences (Botany, zoology, anatomy, biology) and the Buddhist view and meditation; (10) Science (physics, chemistry) and the Buddhist view and meditation; (11) Literacy, Writing Skills and Buddhist ethics and meditation; (12) Numeracy, mathematics and Buddhist ethics and meditation; (13) Algebra; (14) Form drawing and Geometry and awareness; (15) Sustainability studies and Buddhist ecology; (16) Teaching additional languages and Buddha dharma language; (17) Music and contemplation (learning to play traditional and contemporary wind and string instrument; (18) Integrated contemplative science and technologies; (19) Visual arts: painting, drawings, sculpture, modeling; (20) Himalayan Buddhist arts; (21) Wood work and metal work; (22) Craft: traditional and contemporary; (23) Handwork; (24) Games, physical education, yoga and contemplative practices; (25) ICT; (26) Life skill, self-care and health and reproductive education. (27) Literature;

Step 3: Training teachers as per the Teacher training course with add on, custom made courses for the particular group curriculum content relating specifically to their cultural heritage and spirituality. Stage 2: Compiling and Publishing and Translating Curriculum Resources for Teachers and Children. The curriculum resource handbooks include the following: (1) Lesson Handbooks. Handbooks for teachers containing resources for lessons for each year group. Resources will include themes from the curriculum content, such as: nature sciences, life sciences, earth sciences, hard sciences, festivals, cultural studies, agriculture, horticulture science, visual arts, performing arts, arts, crafts, handwork, numeracy, algebra, geometry, literacy, creative writing, literature, social science. (2) Resource Books. The following handbooks are examples of resources for teachers to use when planning lessons for their class: (a) Music and Poetry: Such as songs, rhymes, poems, verses, finger-plays, games, and circle activities. (b) Stories: such as, Folktales, fairy tales, nature stories, mythology, epics. (c) Arts and Crafts: how to make toys, arts and crafts activities for the kindergarten using the materials available from nature, how to make a nature table and how to make a playground. (3) Children's Books. Illustrated books for the children with images and stories from the specific culture and society. (4) Curriculum Guidebooks: handbooks for teachers, including explanations such as, on the routine of the day and its various activities, followed by an explanation of each activity. Curriculum outline and content for each year group. (5) Teaching Reading and Writing Guidebook. A handbook for teachers to teach reading, writing, and basic math to young children in a creative, pictorial, and culturally sensitive way.

Stage 3: Teacher Training: Once the curriculum is compiled, implementation through teacher training begins. The implementation takes place through the Teacher Training courses and a bespoke mentorship program. Transformative Experiential Kindergarten Teacher Training Course Content: Each semester consists of block teachings of 1 to 19 weeks each, such as, Child Development. In addition, each semester includes ongoing classes, such as meditation, arts, handwork and movement.

Semester 1 (Winter/Spring): Transformative Experiential Buddhist Foundation Studies; Duration: 15 weeks online classes+2 reading weeks. Induction and Introduction to Buddhism, Buddhist philosophy: Shravakayana, Buddhist philosophy: Mahayana. (1) Buddhist philosophy: Vajrayana; (2) Karma and biography work; (3) Understanding and practicing Buddhist meditation: Shamata meditation; (4) Understanding and practicing Buddhism: rituals and the four thoughts; (5) Introduction to observation and awareness meditation; (6) Himalayan Buddhist arts; (7) Handwork and mindfulness; (8) Transformative experiential arts related to Buddhist view and philosophy; (9) Personal development group; (10) Music and singing; (11) Arts and crafts and mindfulness and the science of the heart.

Semester 2 (Summer/Autumn): Child Development from Birth to Rebirth: The study of consciousness at the intersection of Buddhism, developmental science and holistic perspectives; Developing Child Observation Skills using awareness meditation and Steinerian observation skills (Goethean science). The Buddhist perspective on the Temperaments and the Ecology and Physiology of the Senses/Consciousness in View, Meditation and Pedagogical Application; Learning theories: Buddhist pedagogy, the transformative learning approach of Rudolf Steiner and other contemporary learning theories leading to the understanding of transformative experiential Buddhist pedagogical approach; Transformative Experiential Buddhist Kindergarten Curriculum Studies. Duration: 19 weeks online classes+2 weeks child observation placement+3 reading weeks. (1) Child development from birth to rebirth: The study of consciousness at the intersection of Buddhism, developmental science and holistic perspectives: (a) Module 1: The intersection of Buddhism, developmental science and holistic perspectives on human development; (b) Module 2: Early childhood: Birth to age 7 from a Buddhist, developmental science and holistic perspectives; (c) Module 3: Middle childhood: Age 7 to 14 from a Buddhist, developmental science and holistic perspectives; (2) Introduction to observation, awareness meditation and the practice of child observation; (3) Child observation practicum (in student's own country); (4) Learning theories: Buddhist pedagogy, the transformative learning approach of Steiner and other contemporary learning theories leading to the understanding of transformative experiential Buddhist pedagogical approach; (5) The Buddhist perspective on the Temperaments and the Ecology and Physiology of the Senses/Consciousness in View, Meditation and Pedagogical Application; (6) transformative experiential Buddhist kindergarten curriculum studies: (a) Transformative experiential Buddhist kindergarten curriculum overview; (b) the Buddhist kindergarten day; (c) towards a bilingual classroom: balancing mother tongue and additional languages, introducing Buddhist philosophy and contemplative language; (d) music and singing; (7) transformative experiential kindergarten curriculum: (a) rhythm of the day and week; (b) working with the rhythm of nature's seasons; (c) understanding each activity of the day: free play, choice, outdoor play, nature walks, crafts, storytelling, circle time; (d) the kindergarten environment; (8) transformative experiential kindergarten curriculum: (a) making nature friendly teaching and learning resources; (b) making nature friendly toys; (9) transformative experiential kindergarten curriculum: woodwork with the kindergarten child; (10) Deepening the understanding and practice of Buddhist meditation for teachers; (11) Himalayan Buddhist arts; (12) Transformative experiential arts related to child development; (13) Handwork and mindfulness; (14) Personal development group: Weekly discussion and group reflective practice; (15) Reading weeks/self-study/writing assignments; (16) Arts and crafts and mindfulness and the science of the heart.

Semester 3 (Winter/Spring): Child Development and Transformative Experiential Buddhist Kindergarten Curriculum Studies. Duration: 15 weeks online classes+2 weeks teaching placement+2 reading weeks. (1) transformative experiential Buddhist kindergarten curriculum: the art and craft of storytelling in pedagogy; age-appropriate stories for kindergarten; nature stories, folktales and fairytales, ahimsa, tread lightly on the earth, interdependence, karma, impermanence. (2) transformative experiential Buddhist kindergarten curriculum: the Buddhist Year: yearly, monthly, weekly, and daily; special occasions. (3) transformative experiential kindergarten curriculum Studies: creating kindergarten learning environment; (4) Child development from birth to rebirth: The study of consciousness at the intersection of Buddhism, developmental science and holistic perspectives: (a) Module 4: Adolescence, age 14 to 21 from a Buddhist, developmental science and holistic perspectives: (b) Module 5: Adult development, 21 to old age from a Buddhist, developmental science and holistic perspectives: lifespan phases; (c) Module 6.1: From the bardos of death to the moment of conception; (d) Module 6.2: Prenatal development from conception to the moment of birth from a Buddhist, Developmental science and holistic perspectives; (d) Module 7: Child development, biography work and the Buddhist view; (5) transformative experiential kindergarten curriculum: (a) Making nature friendly teaching and learning resources; (b) Making nature friendly toys; (6) transformative experiential kindergarten curriculum Studies: teaching spoken English as additional language; (7) Meditation for teachers in relation to pedagogy, and teaching and being with children; (8) Contemplation and meditation on the paramitas in relation to pedagogy and working with children; (9) From child observation to child study: a contemplative practice; (10) Musical instruments and singing for kindergarten; (11) Handwork and awareness meditation; (12) Arts and crafts and mindfulness and the science of the heart; (13) Practicum: teaching placement at a kindergarten; (14) reading weeks/self study/writing assignments.

Semester 4 (Summer/Autumn): Transformative Experiential Kindergarten Curriculum Studies; From an Unhealthy Self Towards a Healthy Self: Safeguarding and Nurturing the Wellbeing of Children with Buddhism in Mind; The compassionate wholesome practice of school organization, management and community building; Duration: 16 weeks online classes+4 weeks teaching placement+2 weeks reading weeks+2 weeks Independent Studies/Project. (1) transformative experiential kindergarten curriculum studies: the Buddhist year: yearly, monthly, weekly, and daily; special occasions. (2) Transformative experiential Buddhism for kindergarten in View; (3) Experiential Buddhism for kindergarten: meditation with young children; (4) The Buddhist year in different Buddhist traditions; (5) transformative experiential kindergarten curriculum studies: The craft of the Buddhist year; (6) transformative experiential kindergarten curriculum studies: The arts and crafts of puppetry; (7) transformative experiential kindergarten curriculum studies: arts and crafts activities with young children and their relation t o holistic child development (watercolor painting, drawing, sewing, wool, finger knitting, paper craft, nature craft); (8) transformative experiential kindergarten curriculum studies: teaching spoken English as additional language; (9) transformative experiential kindergarten curriculum studies: the kindergarten pre-literacy and numeracy curriculum and its creative application; (10) transformative experiential kindergarten curriculum studies: Musical instruments for the kindergarten and singing; (11) Inner development of teacher: Vajrasattva Meditation for teachers; Lojong (Mind training); (12) From an unhealthy self towards a healthy self: Safeguarding and nurturing the wellbeing of children; (13) The compassionate wholesome practice of school organization, management and community building; (14) Meeting local government education requirements; (15) Child study and child assessment and writing reports; (16) Charya Dance; (17) Arts and crafts and mindfulness and the science of the heart; (18) Practicum: teaching placement at a kindergarten; (19) Personal Development Group: Reflective practice.

Transformative Experiential Buddhist Education Primary and Secondary Teacher Trainings (2 separate specializations): Courses Content: Each semester consists of block teachings of 1 to 19 weeks each, such as, Child Development. In addition, each semester includes ongoing classes, such as, meditation, arts, handwork and movement. Please see the daily schedule at the end of the Schedule document that goes along with the Course Content document. Semester 1 (Winter/Spring): Transformative Experiential Buddhist Foundation Studies. Duration: 19 weeks online classes+2 reading weeks. Induction and Introduction to Buddhism, Buddhist philosophy: The Foundational Vehicle, Buddhist philosophy: Mahayana, Buddhist philosophy: Vajrayana. (1) Karma and biography work; (2) Understanding and practicing Buddhist meditation: Shamatha meditation; (3) Understanding and practicing the Buddhist path: rituals and the four thoughts; (4) Simple sadhana recitation and visualization practices; (5) Introduction to observation and awareness meditation; (6) Himalayan Buddhist arts; (7) Handwork and mindfulness; (8) Transformative experiential arts related to Buddhist view and philosophy; (9) Himalayan Buddhist Arts; (10) Personal development group; (11) Music and singing.

Semester 2 (Summer/Autumn): Human Development—Child Development from Birth to Rebirth: The study of consciousness at the intersection of Buddhism, developmental science and holistic perspectives; Developing Child Observation Skills; The Buddhist perspective on the Temperaments and the Ecology and Physiology of the Senses/Consciousness in View, Meditation and Pedagogical Application; Learning theories: Buddhist pedagogy, the transformative learning approach of Rudolf Steiner and other contemporary learning theories leading to the understanding of the transformative experiential Buddhist pedagogical approach; Here trainees choose their specialization or either primary (class 1-8) or secondary (class 7-12). There is an overlap in the division of primary and secondary as different countries define primary and secondary (or high-school) slightly different in terms of year groups. Those who specialize in teaching in secondary education will begin in semester 2. Content of Secondary Curriculum Studies courses is found in Semester 4). Transformative Experiential Buddhist Curriculum Transformative Experiential Buddhist Curriculum for Class 1-2; Duration: 19 weeks online classes+2 weeks school placement+4 reading weeks. (1) Child development from birth to rebirth: The study of consciousness at the intersection of Buddhism, developmental science and holistic perspectives: (a) Module 1: The intersection of Buddhism, developmental science and holistic perspectives on human development; (b) Module 2: Early childhood: Birth to Age 7 from a Buddhist, developmental science and holistic perspectives; (c) Module 3: Middle Childhood: Age 7 to 14 from a Buddhist, developmental science and holistic perspectives; (2) Introduction to observation, awareness meditation and the practice of child observation; (3) Learning theories: Buddhist pedagogy, the transformative learning approach of Rudolf Steiner and other contemporary learning theories leading to the understanding of the transformative experiential Buddhist pedagogical approach; (4) The Buddhist perspective on the Temperaments and the Ecology and Physiology of the Senses/Consciousness in View, Meditation and Pedagogical Application; (5) transformative experiential Buddhist primary curriculum: class 1-8 overview; (6) transformative experiential Buddhist teaching/learning methods: transformative experiential Buddhist curriculum for class 1-2; (7) History, literature, cultural studies and contemplative pedagogy: Literature, literacy and form drawing and nurturing the child's inner life; (8) Morning dharma and contemplative circles; (9) Learning circles and movement; (10) Class 1-2 plays; (11) transformative experiential Buddhist curriculum for Class 1-2: Literature, Literacy and Buddhist ethics (contemplative practices as part of transformative learning); (12) Mathematics, Buddhism in numbers and ethics: Geometry, form drawing Buddhist symbols and the feeling life of the child; (13) Teaching in a bilingual classroom class 1-2: (a) Integrated and experiential additional languages teaching/learning methodology and application; (b) Literacy teaching in a bilingual classroom; (14) transformative experiential Buddhist curriculum for class 1-2: (a) Sense-based science and Buddhism; (b) Nature studies (sustainability curriculum) and Buddhist ecology; (15) Transformative experiential arts curriculum for Class 1-2: (a) Watercolor painting; (b) Drawings with crayons; (c) Shade drawing; (d) Clay modeling; (16) Meditation practice for class 1-2; (17) Experiential Buddhism/contemplative practices for class 1-2: Musical instruments and singing for class 1-2; (18) Handwork and mindfulness for class 1-2; (19) Making teaching and learning resources for class 1-2; (20) Movement and games for class 1-2; (21) Deepening the understanding and practice of Buddhist meditation for teachers; (22) Himalayan Buddhist arts: Thangka painting; (23) Himalayan Buddhist arts: Charya Dance; (24) Transformative experiential arts related to child development; (25) Child observation and assessment; (26) From child observation to child study: a contemplative practice; (27) Personal Development Group: Weekly discussion and group reflective practice; (28) Reading weeks/self study/writing assignments; (29) Arts and crafts and mindfulness and the science of the heart; (30) Practicum: teaching placement at a primary school in Class 1-2.

Semester 3 (Winter/Spring): Child Development from Birth to Rebirth: The study of consciousness at the intersection of Buddhism. developmental science and holistic perspectives; Transformative Experiential Primary Curriculum for class 3-6; Duration: 17 weeks online classes +1 week teaching placement +2 reading weeks: (1) Child development from birth to rebirth: The study of consciousness at the intersection of Buddhism, developmental science and holistic perspectives: (a) Module 4: Adolescence, age 14 to 21 from a Buddhist, developmental science and holistic perspectives; (b) Module 5: Adult development, 21 to old age from a Buddhist, developmental science and holistic perspectives: lifespan phases; (c) Module 6.1: From the bardos of death to the moment of conception; (d) Module 6.2: Prenatal development from conception to the moment of birth from a Buddhist, Developmental science and holistic perspectives; (e) Module 7: Child development, biography work and the Buddhist view; (2) From child observation to child study: a contemplative practice; (3) Meditation for teachers in relation to pedagogy, teaching and being with children; (4) Contemplation and meditation on the paramitas in relation to pedagogy and working with children; (5) Deepening the understanding and practice of Buddhist meditation; (6) transformative experiential curriculum for class 3-4: (a) Mathematics and Buddhist ethics; (b) Geometry, form drawing, Buddhist symbols and nurturing the feeling life of the child; (7) transformative experiential Buddhism for class 3-4: (a) Teaching in a bilingual classroom class 3-4; (b) Integrated and experiential additional languages teaching/learning methodology and application; (c) Literacy teaching in a bilingual classroom; (8) transformative experiential Buddhis curriculum for class 3-4: (a) Buddhism and sense-based sciences; (b) Sustainability education embedded within Buddhist ecology; (9) transformative experiential curriculum for class 3-4: Literature, history, cultural studies and Buddhism integrated with literacy and developing composition skills; (10) Child Observation and Assessment; (11) Musical instruments and singing for class 1-8; (12) Making teaching and learning resources for class 3-4; (13) Transformative experiential arts curriculum for class 3-4: (a) watercolor painting; (b) calligraphy; (c) shade drawing with color pencils; (d) clay modeling; (14) Handwork and mindfulness for class 3-4; (15) Movement and games for class 3-4; (16) transformative experiential curriculum for class 5-6: Developing writing skills, composition, grammar, spelling, creative writing and poetry; (17) transformative experiential curriculum for class 5-6: Literature, history, cultural studies and Buddhism; (18) transformative experiential curriculum for class 5-6: Integrated and experiential additional languages teaching/learning methodology and application; (19) transformative experiential curriculum for class 5-6; (20) Drama and class plays; (21) Geometric drawings and Tibetan Thangka Painting; (22) Himalayan Buddhist arts: Charya Dance; (23) Practicum: teaching placement at a primary school in Class 3-6; (24) Movement, physical education and games for class 5-8; (25) Arts and crafts and mindfulness and the science of the heart.

Semester 4 (Summer/Autumn): Transformative Experiential Primary Curriculum for Class 5-8: From an unhealthy self towards a healthy self: safeguarding and nurturing the wellbeing of children with Buddhism in mind: The Compassionate Practice of School organization, Management and Community Building. Duration: 19 weeks online classes+2 weeks teaching placement+2 weeks child observation placement+2 reading weeks: (1) transformative experiential Buddhist Curriculum for Class 5-6: Experiential Buddhism: Contemplative practices and Buddhist View for class 5-6; (2) transformative experiential curriculum for class 5-6: Experiential Buddhism: Shamata meditation; (2) transformative experiential curriculum for class 5-6: Mathematics and ethics; (3) Geometry and the student's inner landscape: Algebra and logic; (4) transformative experiential curriculum for class 5-6: Drama and class plays; (5) transformative experiential curriculum for class 5-6: Musical instruments and singing; (6) transformative experiential curriculum for class 5-6: Movement, physical education and games; (7) transformative experiential curriculum for class 5-6: Woodwork for class 5-6; (8) transformative experiential curriculum for class 7-12: Handwork and mindfulness; transformative experiential curriculum for class 7-12: Woodwork for class 7-12; (9) transformative experiential Buddhist curriculum for class 7-12: (a) Sense-based sciences and Buddhism; (b) Sustainability curriculum and Buddhist ecology; (10) transformative experiential curriculum for class 7-12: Teaching in a bilingual classroom: Curriculum and teaching methodology; (11) transformative experiential curriculum for class 7-12: Movement, physical education and games; (12) transformative experiential Buddhist curriculum for class 7-12: (a) Introduction to Buddhist philosophy; Foundation of Buddhist philosophy or view—the three baskets: sutras, vinaya and abhidharma (b) Introduction to texts by great Indian and Tibetan Buddhist master; (c) Foundation of Buddhist Experience or Experiential Buddhism: shamata meditation and introduction to vipassana; (d Introduction to Buddhist logic; (e) Introduction to debate practice; (f) Becoming familiar with Buddhist terminology in English, Sanskrit and Tibetan languages; (13) transformative experiential curriculum for class 7-12: (a) Mathematics; (b) Geometry; (c) Algebra; (14) transformative experiential curriculum for class 7-12: (a) Literature, History, cultural studies and Buddhism; (b) Class plays; (c) (15) transformative experiential curriculum for class 7-12: Developing writing skills, composition, grammar, spelling, creative writing and poetry, commentary book: Writing our own commentary book—the writing portfolio includes all writing reflections on how they are learning and helpful strategies to use when reading or writing. Learn to Paraphrase the section of the root text taught that day. Learning to write summaries and effective note-taking. Analyse complex texts for meaning. This includes paragraph format with a beginning, middle, and end composition format with a clear beginning, middle, and end—potentially all of the above purposes, Learn to compare and contrast, Write opinion related essay, Construct an argument in writing as an essay—includes understanding your audience, writing arguments and counterarguments about themes in texts, and supporting their positions with details, Position essays-synthesise, analyse, and critique, Collection of quotes and famous Buddhist poetry—students copy or create important quotes or poetry about the text they are learning or a sentence from the relevant text. Make use of calligraphy. Students create commentary book for each specific topic with all of the above writing.

(16) transformative experiential curriculum for class 7-12: (a) Drama and class plays; (b) (17) transformative experiential curriculum for class 7-12: Musical instruments and singing; (18) transformative experiential curriculum for class 7-12: Movement, physical education and games; (19) transformative experiential curriculum for class 7-12: Woodwork and mindfulness; (20) transformative experiential curriculum for class 7-12: Handwork and mindfulness; (21) transformative experiential curriculum for class 7-12: Arts and awareness meditation; (22) From an unhealthy self towards a healthy self: safeguarding and nurturing the wellbeing of children with Buddhism in mind; (23) Child assessment and writing reports; (24) Meeting local government education requirements; (25) The compassionate wholesome practice of school organisation, management and community building; (26) Practicum: Teaching placement at a primary school in Class 6-8 or 7-12 depending if specializing in teaching primary or secondary school children; (27) Child observation practicum (in student's own country); (28) Himalayan Buddhist arts: Charya Dance; (29) Inner Development of the Teacher: Vajrasattva Meditation, Lojon (mind training); (30) Meditation for Teachers: Vipassana Meditation—Deepening, Shamatha and Vipassana and contemplating the paramitas (virtues); (31) Meditation for Teachers: Revisiting Meditation practices from previous semesters; (32) Arts and crafts and mindfulness and the science of the heart.

Students Assessment: (1) Students are assessed throughout the course on the basis of: attendance, active class participation, tutorials, written assignments, oral presentations, reflective practice, observation exercises, curriculum planning and preparation of teaching activities. (2) Students are required to successfully complete the assignments. (3) Students are required to attend 80% of the course classes. (4) Practicum/practice teaching: (a) In semesters 3-4, students will practice teaching at a school of their choice. During each teaching placement students will be expected to write a reflective journal, keep a record of class plans, and be assessed by a tutor; (b) During semester 4, practicum students are expected to lead a class for a week or more and be assessed on their ability to manage the aspects of running a school day.

Referring now to FIG. 1, an exemplary method for developing a curriculum and training teachers includes, but is not limited to including, gathering 101 local data, establishing 103 a demonstration class and curriculum, determining 105 curriculum resources, creating 107 teacher training materials based on the data, the curriculum and the curriculum resources, training 109 teachers based on the teacher training materials, and following up 111 with the trained teachers with mentoring and assessments based on the teacher training materials. In an aspect, the step of gathering data includes interviewing a local population about the areas of their lives that form their local culture, local government, economy, social structure, and other areas. The interviewing can be a manual process or can be partially or totally automated. For example, the local population or a subset of the local population can answer survey questions, or can enable automatic data gathering which can include applications executing on handheld devices or, for example, watches. After the data are gathered, they are used to develop classes and curricula. Lesson books and other types of resources are gathered, and teacher training materials are created based on the data, the curricula, the available lesson books, and the available resources. The teachers are trained using the teacher training materials, and the teachers begin teaching classes. The teachers are mentored and assessed as they are teaching.

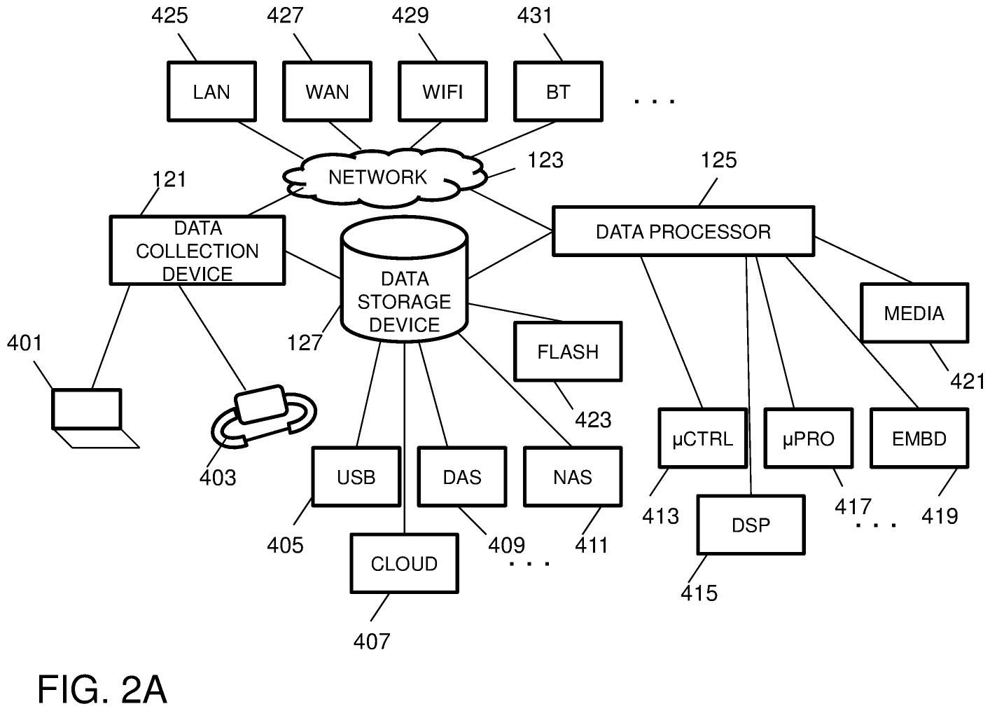

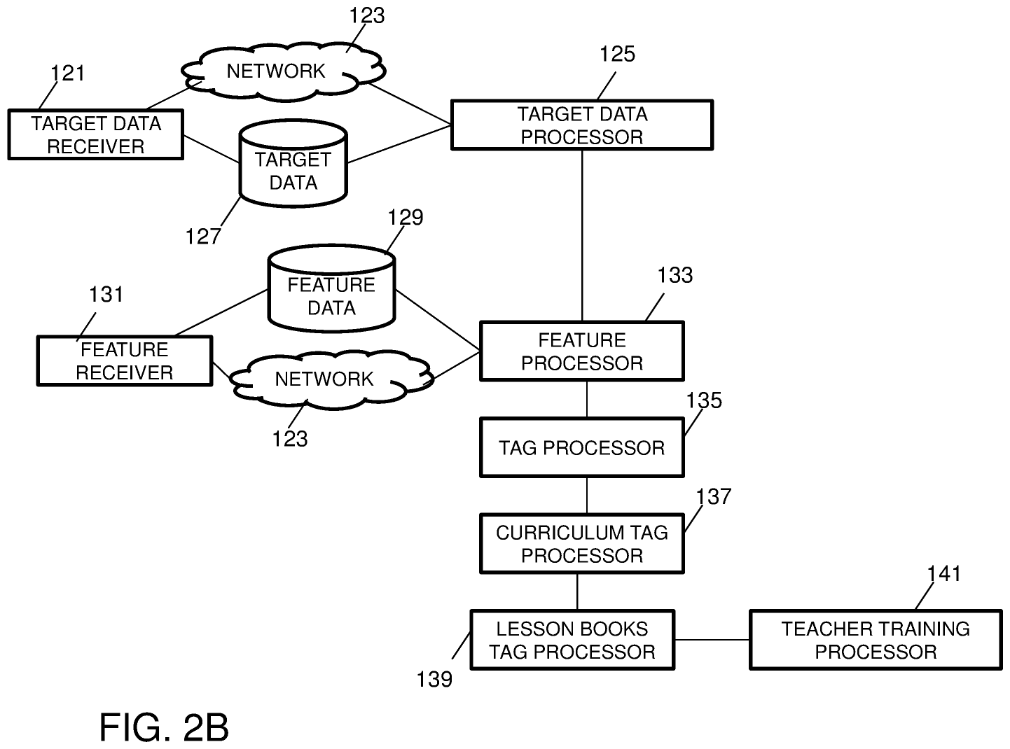

Referring now to FIG. 2A, an exemplary hardware configuration for implementing the system of the present teachings in shown. Data move through the system beginning with data collection device 121 that collects both target data and features data. In an aspect, data are collected by collection processor 401 that enables, for example, user data entry, among other types of data entry. In an aspect, data enter the system through audio data entry. In an aspect, data enter the system through typed data entry. In an aspect, data enter the system through storage media. Other data entry means are contemplated by the present teachings. In an aspect, data are entered automatically through, for example, user-wearable device 403 that collects environmental or user-supplied data as the wearer navigates daily life. In an aspect, data are generated based on collected data. In an aspect, the user is prompted for data.

Continuing to refer to FIG. 2A, collected data are stored or sent directly for processing. In an aspect, data collection device 121 sends data directly to data processor 125, or sends data through network 123 to data processor 125. In an aspect, data processor 125 is a microcontroller 413, a microprocessor 417, an embedded processor 419, a digital signal processor 415, or a media processor 421, among others. In an aspect, network 123 is a local area network 425, a wide area network 427, a wifi network 429, a Bluetooth network 431, or any network that can relay data between collection device 121 and data processor 125 with enough speed to receive, process, and store the data without data loss and/or corruption. In an aspect, data storage device 127 is, for example, but not limited to, a USB 405, a cloud storage area 407, a flash drive 423, direct attached storage 409, and network attached storage 411, individually or a combination of the types.

Referring now to FIG. 2B, an exemplary system for developing curricula and training teachers includes, but is not limited to including, target data receiver 121 collecting and storing target data 127, which are accessed, either directly or through network 123, by target data processor 125. With respect to local culture, target data include religious, ethnographic, and learning methodology information. With respect to the local religious culture, target data include philosophy, ethics, values, ceremonies, rituals, and understanding of human development and nature of reality information. These data are categorized according to their relationship to contemplative science and Buddhist universal values. With respect to local ethnography, target data include rituals, ceremonies, traditional cultural knowledge, and family values information. These data are categorized according to their relationship with contemplative science. Information is collected about local traditional learning methodology for children and adults. Target data include information about agriculture, rituals, and spirituality in the target area, for example. In an aspect, target data receiver 121 is an automated survey completed by members of the target population who enter their data at a pre-programmed computer. Such surveys are readily available commercially, or they can be custom-built. In an aspect, target data receiver 121 is a smart watch. In an aspect, the smart watch executes one of many available applications that collects information about the wearer and supplies the information to a processor such as target data processor 125. In an aspect, if a subset of the desired amount of data are collected, software executing in target data receiver 121 or target data processor 125, or both, supplies the missing data. In an aspect, the supplied data are derived from default values associated with the target population, for example. In an aspect, the supplied data are computed based upon the combination of data values entered. In an aspect, the algorithms relied upon to combine the data are commercially available, user-supplied, or dynamically determined. In an aspect, the communications between the source of the target data and target data processor 125 is wireless through commercially-available protocols. In an aspect, the communications between the source of the target data and target data processor 125 is wireless. In an aspect, the source of the target data can enter the target data manually. In an aspect, the data exchanged between target data receiver 121 and target data processor 125 is encrypted for the protection of target data 127 and the source of target data 127.

Continuing to refer to FIG. 2B, feature receiver 131 collects features that are important for developing the curricula and teacher training. In an aspect, features include nature, the economy, social values, religious/spiritual beliefs, and cultural heritage of the target population. In general, features include general aspects of interest giving context about target population and geography, while target data include specific aspects of the target population. Feature receiver 131 receives feature data 129. In an aspect, feature data 129 are provided by manual input, either through a user interface such as a keyboard connected to a computer with a direct connection to a storage device, or a connection through network 123 to a storage device. In an aspect, user input is provided to a handheld device through a wireless interface. In an aspect, feature receiver 131 collects data automatically from remote collection devices such as digital feeds from financial entities. In an aspect, feature receiver 131 processes these data and stores them as feature data 129. Feature data 129 are tagged according to which of a pre-selected list of categories the data fall into. Each element of a curriculum is associated with one or more categories. Thus, the feature data and target data associated with each of the categories is automatically associated with the curriculum element that is also associated with the categories. Likewise, lesson materials are associated with the categories, and populated with feature and target data. The curriculum and lesson resources are used to create teacher training. In an aspect, several processors execute sequentially or asynchronously to create the teacher training. In an aspect, the processors include feature processor 133 assigns tags to feature data 129 depending upon the content of feature data 129. In an aspect, tag assignment is a computer-assisted process in which a word search is conducted in feature data 129 to determine one or more category matches. In an aspect, feature processor 133 determines possible category matches, while tag processor 135 assigns tags to feature data 129. In an aspect, curriculum tag processor 137 assigns tagged data to curriculum categories and lesson books tag processor 139 creates lesson books and locates resources based at least on the populated curriculum categories. In an aspect, teacher training processor 141 creates teacher training curricula based upon the resources and populated curriculum categories. In an aspect, the steps stated herein are accomplished by either a single processor or by multiple processors in parallel.

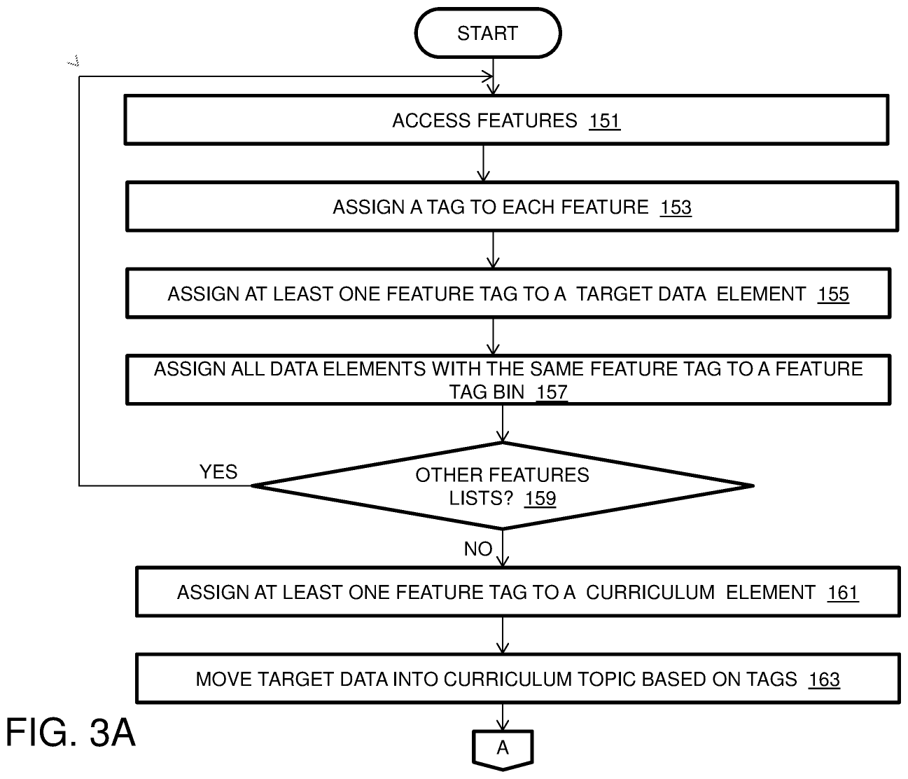

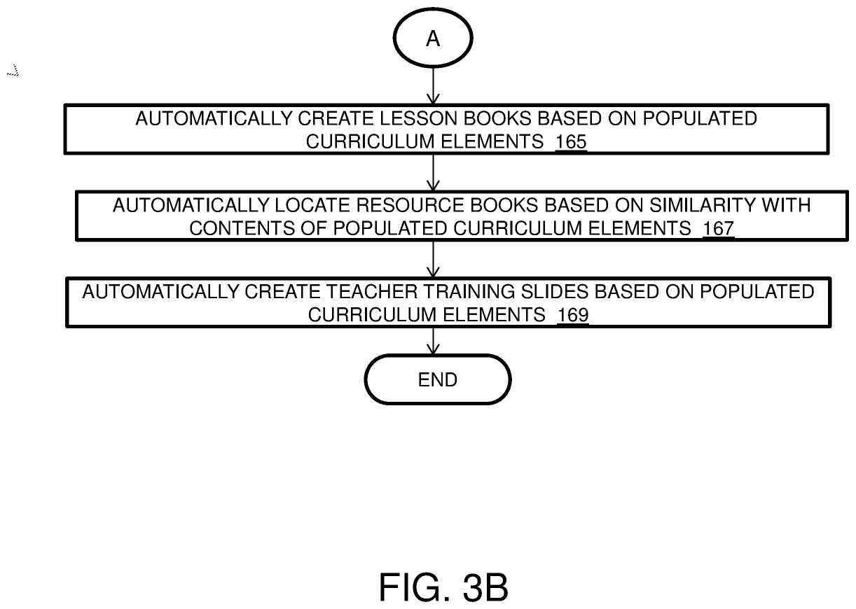

Referring now to FIGS. 3A-3B, an exemplary method for creating a teacher training curriculum includes, but is not limited to including, accessing 151 features, assigning 153 a tag to each feature, assigning 155 at least one feature tag to a target data element, and assigning 157 data elements with the same feature tag to a feature tag bin. If 159 there are other feature lists, the method begins again at step 151. If 159 the feature lists have been examined, the method can include assigning 161 at least one feature tag to a curriculum element, and moving 163 target data into a curriculum topic based on the tags. The method further includes automatically creating 165 lesson books based on populated curriculum elements, automatically locating 167 resource books based on similarity with contents of the populated curriculum elements, and automatically creating 169 teacher training slides based on the populated curriculum elements.

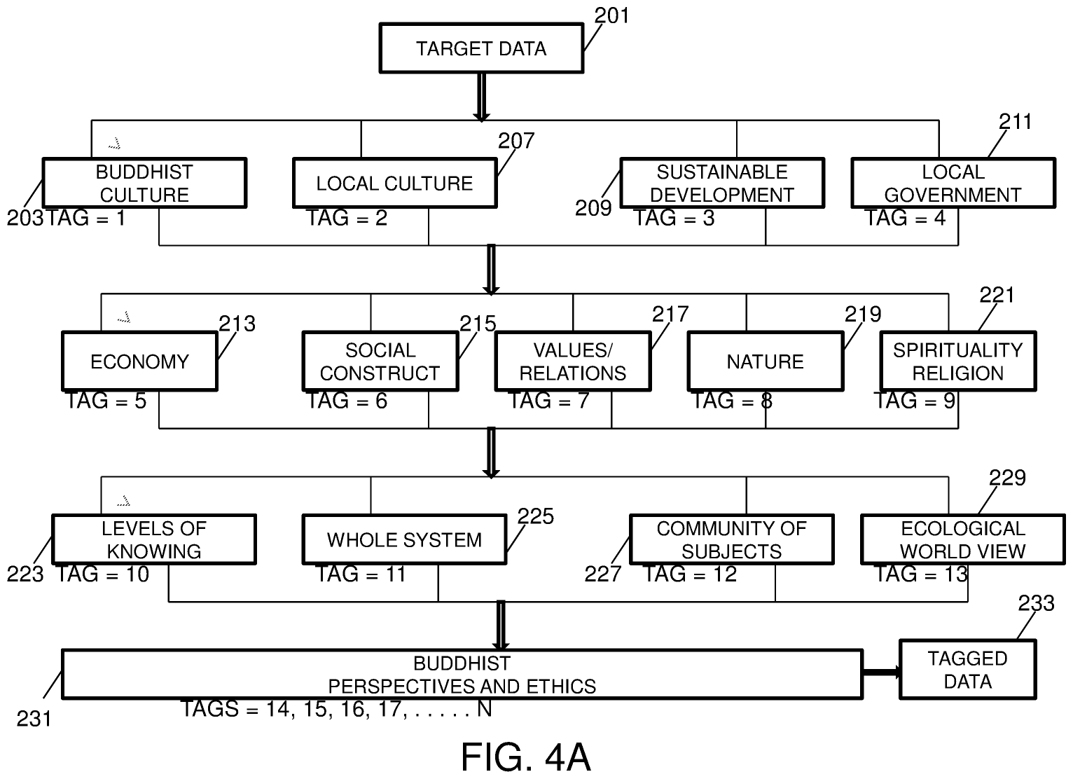

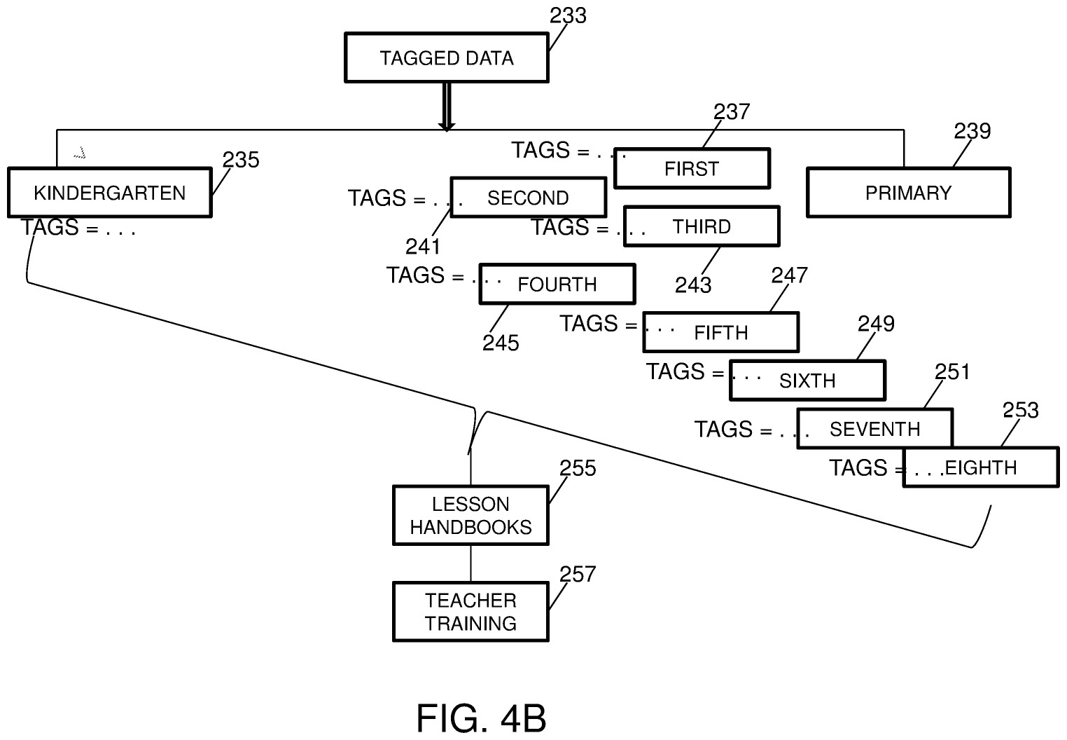

Referring now to FIGS. 4A-4B, a first exemplary configuration of the system of the present teachings is illustrated in data diagram form. Referring to FIG. 4A, target data 201 are tagged according to what category target data 201 naturally fit into. Exemplary categories include Buddhist culture 203 (tag=1), local culture 20 (tag=2), sustainable development 209 (tag=3), and local government 211 (tag=4). Any number and types of categories can be used to sort target data 201. When the first step of tagging target data 201 is complete, the tagged data and then further sorted into feature categories. Exemplary feature categories include economy 213 (tag=5), social construct 215 (tag=6), values/relations 217 (tag=7), nature 219 (tag=8), and spirituality/religion 221 (tag=9). Any number of features can be included. When the tagged target data are sorted according to features, each of the features will possibly include a set of tagged target data. The process proceeds to further sorting as shown, with tags 10-13 corresponding to levels of knowing 223, whole system 225, community of subjects 227, and ecological world view 229. When the categories have been populated, including Buddhist perspectives and ethics (tags=14-N), a dataset of tagged data 233 is available.

Referring to FIG. 4B, tagged data 233 are sorted based on their relevance to curriculum elements. For example, data from tagged data 233 could be appropriate for kindergarten curriculum 235, or primary curriculum 239. Primary curriculum 239 can include first 237, second 241, third 243, fourth 245, fifth 247, sixth 249, seventh 251, and eighth 253 classes. Any number and types of classes can be used to sort tagged data 233. For example, it might be desired to combine classes third 243 and fourth 245. Tags can be assigned to any classes as appropriate. For example, data tagged with tag=5 can be associated with classes second 241 and sixth 249. Such assignments might be more likely if the categories are broad, whereas more narrow categories would likely be associated with a single curriculum class. Tagged information is used to create lesson handbooks 255 and teacher training 257.

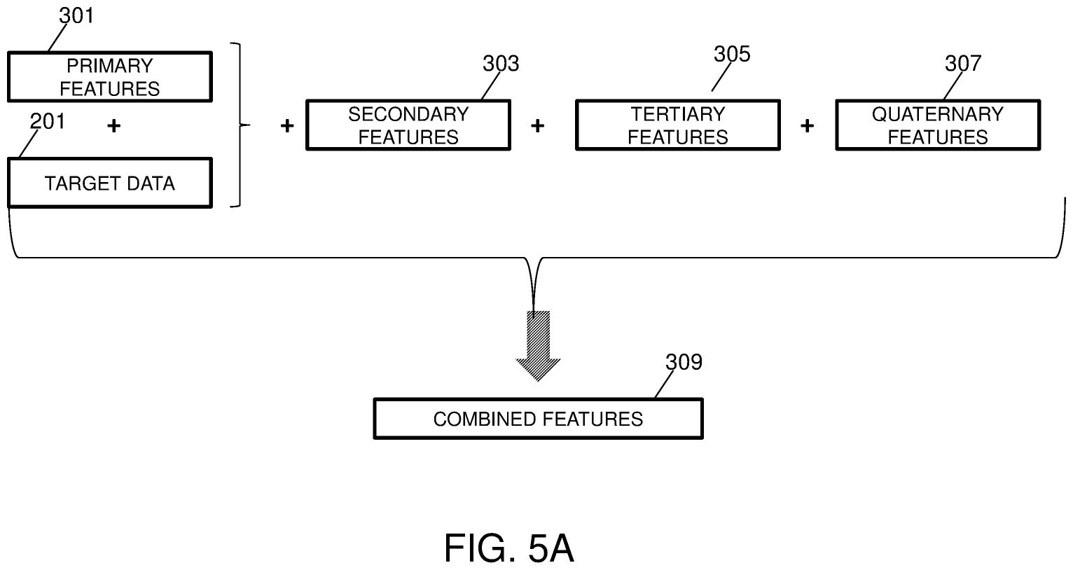

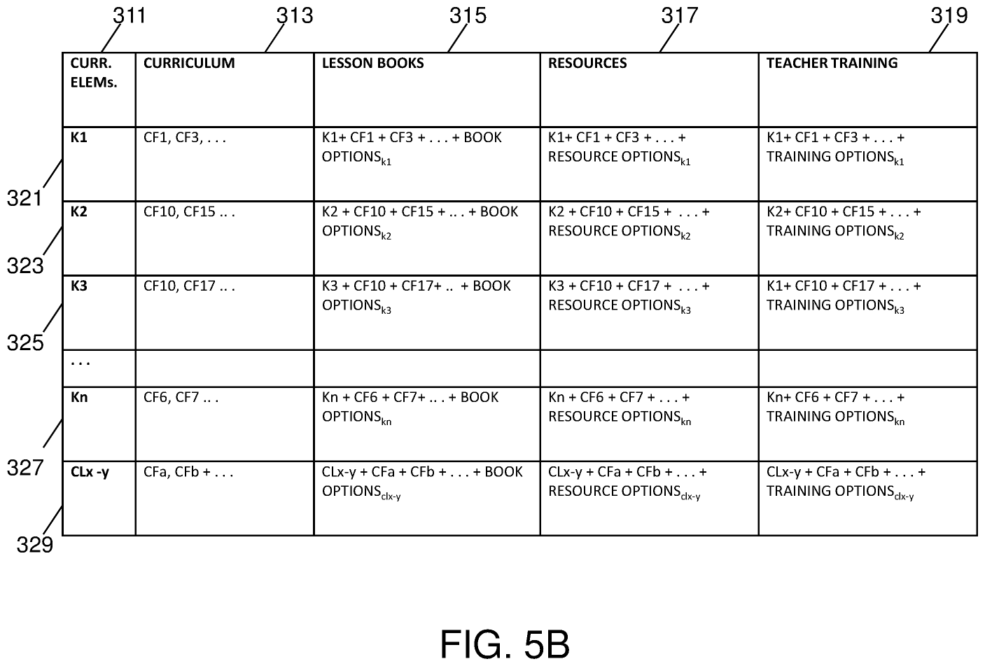

Referring now to FIGS. 5A-5B, another exemplary implementation of the system of the present teachings includes a natural language sorting technique. Referring now to FIG. 5A, specifically, a group of features, for example, primary features 301, are “matched” with target data 201 by techniques described herein. The result of the match is then matched with other features until a list of combined features 309 has been arrived at. In the exemplary implementation, the result of the first match can be matched with secondary features 303, the result from which is matched to tertiary features 305, the result from which is matched to quaternary features 307.

Referring now to FIG. 5B, the combined features are associated with curriculum elements 311, and used to create curricula 313, and lesson books 315, resources 317, and teacher training 319 associated with the specific curriculum. For example, curriculum element K1 321 is shown to be associated with combined features 1 and 3. Lesson books 315 for curriculum element K1 321 result from sorting the book options based on the curriculum element and the combined features through a natural language hit process. Likewise resources 317 for curriculum element K1 321 result from sorting the resource options based on the curriculum element and the combined features through a natural language method. With the lesson books and resources determined, the teacher training curriculum for curriculum element K1 321 results from sorting the training options (which can be done based on the lesson books and resources) based on the curriculum element and the combined features through a natural language method. Other curriculum elements K2 323, K3 325, Kₙ, 327, and CL_{x+y} 329 are described similarly to curriculum element K1 321.

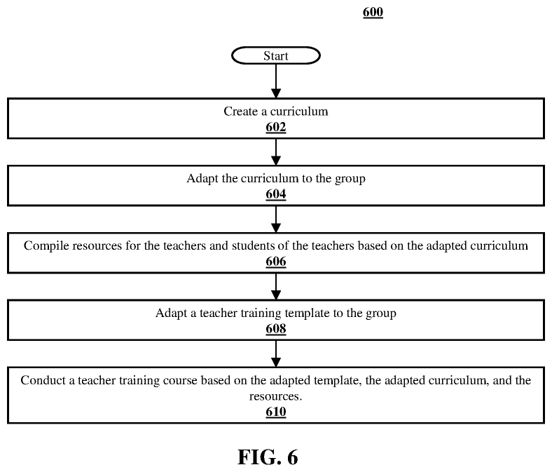

Referring now to FIG. 6, method 600 for training teachers to provide a bespoke curriculum for a group can include, but is not limited to including, creating 602 a curriculum, adapting 604 the curriculum to the group, compiling 606 resources for the teachers and students of the teachers based on the adapted curriculum, adapting 608 a teacher training template to the group, and conducting 610 a teacher training course based on the adapted template, the adapted curriculum, and the resources.

The method 600 can optionally include wherein creating the curriculum includes accessing a first content from Buddhist philosophy, Buddhist view, meditation and application, Buddhist ethics, rituals, ceremonies, prayers, customs, practices, shamata and vipassana meditation, deities practices, developmental and completion Buddhist meditation practices, a transformational education approach, and a progressive education approach, accessing a second content from a philosophy, ethics, values, experiential, meditation, conduct, ceremonies, and rituals of the group, accessing a third content from rituals, ceremonies, and cultural knowledge of individuals in the group, accessing a fourth content from teaching methodologies of the group, accessing a fifth content from teaching methodologies of sustainable practices of the group, forming an ordered list by merging the first content with the second content, the third content, the fourth content, and the fifth content, and modifying the ordered list according to laws of the group to form the curriculum. The method 600 can optionally include wherein adapting the curriculum includes studying the group, creating lessons appropriate to an age of the students, the lessons integrating ontology, epistemology, and a spiritual tradition of the group, and creating explanations of the lessons for the teachers. The method 600 optionally includes translating the resources to a language of the group. The method 600 optionally includes wherein the group comprises a culture, religious, or ethnic group.

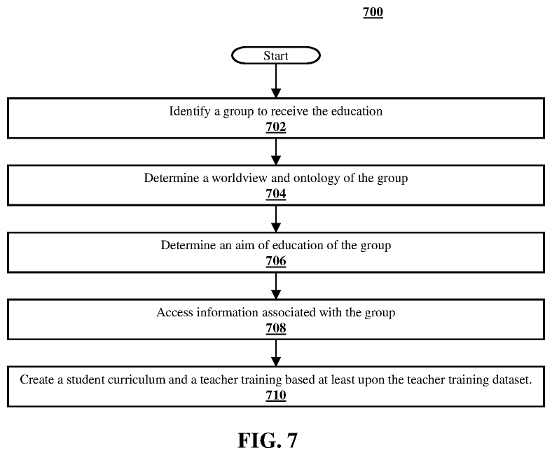

Referring now to FIG. 7, a method 700 for developing a bespoke transformative experiential education can include, but is not limited to including, identifying a group to receive the education, determining a worldview and ontology of the group, determining an aim of education of the group, accessing information associated with the group, determining methodology and philosophy of education of the group, creating a teacher training dataset by processing the worldview, the ontology, the aim of education, the information, and the methodology and philosophy of education according to a Buddhist learning methodology, a transformational education approach, and a progressive education approach, and creating a student curriculum and a teacher training based at least upon the teacher training dataset.

The method 700 can optionally include wherein the information includes religious and spiritual experience and knowledge, spiritual beliefs and rituals, philosophy, ethnography, traditional cultural knowledge, social norms and practices, local environment, wilderness, farming, sustainable development. The method 700 optionally includes wherein creating the student curriculum includes accessing a first content from Buddhist philosophy, Buddhist view, meditation and application, Buddhist ethics, rituals, ceremonies, prayers, customs, practices, awareness, shamata and vipassana meditation, deities practices, nature of mind meditation practices, a transformational education approach, and a progressive education approach, accessing a second content from a philosophy, ethics, values, experiential, meditation, conduct, ceremonies, and rituals of the group, accessing a third content from rituals, ceremonies, and cultural knowledge of individuals in the group, accessing a fourth content from teaching methodologies of the group, accessing a fifth content from teaching methodologies of sustainable practices of the group, forming an ordered list by merging the first content with the second content, the third content, the fourth content, and the fifth content, and modifying the ordered list according to laws of the group to form the student curriculum. The method 700 optionally includes wherein creating the student curriculum includes studying the group, creating lessons appropriate to an age of students, the lessons integrating ontology, epistemology, and a spiritual tradition of the group, and creating explanations of the lessons for the teachers. The method 700 optionally includes translating the teacher training dataset to a language of the group. The method 700 optionally includes wherein the group comprises a culture, religious, or ethnic group. The method 700 optionally includes wherein the transformational education approach comprises Waldorf education. The method 700 optionally includes wherein the information includes rituals, ceremonies, traditional cultural knowledge, and family values information categorized according to their relationship with contemplative science.

Configurations of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. Parts of the system can operate on a computer having a variable number of CPUs. Other alternative computer platforms can be used.

The present configuration is also directed to software for accomplishing the methods discussed herein, and computer readable media storing software for accomplishing these methods. The various modules described herein can be accomplished on the same CPU, or can be accomplished on a different computer. In compliance with the statute, the present configuration has been described in language more or less specific as to structural and methodical features. It is to be understood, however, that the present configuration is not limited to the specific features shown and described, since the means herein disclosed comprise forms of putting the present configuration into effect.

Methods can be, in whole or in part, implemented electronically. Signals representing actions taken by elements of the system and other disclosed configurations can travel over at least one live communications network. Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

While the present teachings have been described above in terms of specific configurations, it is to be understood that they are not limited to these disclosed configurations. Many modifications and other configurations will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A method for training teachers to provide a bespoke curriculum for a group comprising:
creating a curriculum;
adapting the curriculum to the group;
compiling resources for the teachers and students of the teachers based on the adapted curriculum;
adapting a teacher training template to the group; and
conducting a teacher training course based on the adapted template, the adapted curriculum, and the resources.

2. The method as in claim 1 wherein creating the curriculum comprises:
accessing a first content from Buddhist philosophy, Buddhist view, meditation and application, Buddhist ethics, rituals, ceremonies, prayers, customs, practices, shamata and vipassana meditation, deities practices, a transformational education approach, and a progressive education approach;
accessing a second content from a philosophy, ethics, values, experiential, meditation, conduct, ceremonies, and rituals of the group;
accessing a third content from rituals, ceremonies, and cultural knowledge of individuals in the group;
accessing a fourth content from teaching methodologies of the group;
accessing a fifth content from teaching methodologies of sustainable practices of the group;
forming an ordered list by merging the first content with the second content, the third content, the fourth content, and the fifth content; and
modifying the ordered list according to laws of the group to form the curriculum.

3. The method as in claim 1 wherein adapting the curriculum comprises:
studying the group;
creating lessons appropriate to an age of the students, the lessons integrating ontology, epistemology, and a spiritual tradition of the group; and
creating explanations of the lessons for the teachers.

4. The method as in claim 1 further comprising:
translating the resources to a language of the group.

5. The method as in claim 1 wherein the group comprises:
a culture, religious, or ethnic group.

6. A system for developing curricula for a group and training teachers comprising:
a processor executing instructions including:
collecting and tagging target data, the tagging being based upon an association between the target data and one or more members of a pre-selected list of categories;
receiving and tagging feature data, the tagging being based upon an association between the feature data and one or more members of the pre-selected list of categories;
associating lesson materials with one or more members of the pre-selected list of categories;
automatically populating elements of the curricula with the target data, the feature data, and the lesson materials by associating each element of the curricula with one or more members of a pre-selected list of categories;
locating resources based at least upon the populated elements of the curricula; and
creating teacher training curricula and teacher training materials based at least upon the curricula and the resources.

7. The system as in claim 6 wherein the pre-selected list of categories comprises:
Buddhist culture, local culture, sustainable development, local government, economy, social construct, values/relations, nature, spirituality/religion, levels of knowing, whole system, community of subjects, ecological world view, and Buddhist perspectives and ethics.

8. The system as in claim 6 further comprising:
automatically deriving or supplying missing of the target data.

9. The system as in claim 6 wherein the target data comprise:
data about culture of the group; and
data about agriculture, rituals, and spirituality in a region occupied by the group.

10. The system as in claim 9 wherein the data about the culture of the group comprise:
religious information, ethnographic information, and learning methodology information about the group.

11. The system as in claim 10 wherein the data about the religious information of the group comprise:
philosophy, ethics, values, ceremonies, rituals, and understanding of human development and nature of reality information categorized according to their relationship to contemplative science and Buddhist universal values.

12. The system as in claim 10 wherein the data about the ethnographic information of the group comprise:
rituals, ceremonies, traditional cultural knowledge, and family values information categorized according to their relationship with contemplative science.

13. A method for developing a bespoke transformative experiential education comprising:
identifying a group to receive the education;
determining a worldview and ontology of the group;
determining an aim of education of the group;
accessing information associated with the group;
determining methodology and philosophy of education of the group;
creating a teacher training dataset by processing the worldview, the ontology, the aim of education, the information, and the methodology and philosophy of education according to a Buddhist learning methodology, a transformational education approach, and a progressive education approach; and
creating a student curriculum and a teacher training based at least upon the teacher training dataset.

14. The method as in claim 13 wherein the information comprises:
religious and spiritual experience and knowledge, spiritual beliefs and rituals, philosophy, ethnography, traditional cultural knowledge, social norms and practices, local environment, wilderness, farming, sustainable development.

15. The method as in claim 13 wherein creating the student curriculum comprises:
accessing a first content from Buddhist philosophy, Buddhist view, meditation and application, Buddhist ethics, rituals, ceremonies, prayers, customs, practices, shamata and vipassana meditation, deities practices, a transformational education approach, and a progressive education approach;
accessing a second content from a philosophy, ethics, values, experiential, meditation, conduct, ceremonies, and rituals of the group;
accessing a third content from rituals, ceremonies, and cultural knowledge of individuals in the group;
accessing a fourth content from teaching methodologies of the group;
accessing a fifth content from teaching methodologies of sustainable practices of the group;
forming an ordered list by merging the first content with the second content, the third content, the fourth content, and the fifth content; and
modifying the ordered list according to laws of the group to form the student curriculum.

16. The method as in claim 13 wherein creating the student curriculum comprises:
studying the group;
creating lessons appropriate to an age of students, the lessons integrating ontology, epistemology, and a spiritual tradition of the group; and
creating explanations of the lessons for the teachers.

17. The method as in claim 13 further comprising:
translating the teacher training dataset to a language of the group.

18. The method as in claim 13 wherein the group comprises:
a culture, religious, or ethnic group.

19. The method as in claim 13 wherein the transformational education approach comprises:
Waldorf education.

20. The method as in claim 13 wherein the information comprises:
rituals, ceremonies, traditional cultural knowledge, and family values information categorized according to their relationship with contemplative science.
